(19) United States
(12) Patent Application Publication
(10) Pub. No.: US 2011/0087367 A1
(43) Pub. Date: Apr. 14, 2011

(54) Dispenser and Support for Dispensing Doses of a Deliverable Substance

(75) Inventors: Costanzo Gadini, Alessandria (IT); Renato Gaj, Alessandria (IT); Chris Efstathios Housmekerides, Ludwigshafen (DE); Marco Moro, Alessandria (IT)

(73) Assignee: Reckitt Benckiser N.V., Hoofddorp (NL)

(21) Appl. No.: 12/672,395

(22) PCT Filed: Aug. 6, 2008
(86) PCT No.: PCT/GB08/02667

§ 371 Date: Sep. 1, 2010

(30) Foreign Application Priority Data
Aug. 10, 2007 (IT) MI2007A001667

(51) Int. Cl. G06F 17/00; B65D 83/04; F16M 13/02; B65D 83/00; A47B 96/00; B29C 45/14; B67D 7/00

(52) U.S. Cl. 700/231; 206/532; 248/224.8; 221/283; 211/49.1; 264/328.1; 222/1

(57) ABSTRACT

A support (40) contains a plurality of separate doses (46) of deliverable substances. The support is arranged to be operatively coupled to a long-life dispensing device. The support is intended to be either coupled to or inserted within the dispensing device, such that a relative movement of the support and at least one part of the dispenser body that is caused by an actuating system allows selectively delivering at least one substance dose. The support integrates reference means (49a), (49b) that are configured to provide, due to said relative movement, information on at least one of:
doses of the substance provided within the support,
a condition and/or a position of the support within the dispenser.

The present invention relates to a support, such as a support for a plurality of doses of at least one substance deliverable from a dispensing device or dispenser.

The present invention has been developed with particular reference to a support, cartridge or refill intended for use in combination with long-life dispensers for domestic ware washing machines, i.e. dispensers arranged to retain and deliver an amount of a washing agent sufficient for carrying out several operating cycles of the respective ware washing machine. The support according to the invention can be, however, advantageously applied also to dispensers for domestic equipment other than ware washing machines, and to hydraulic equipment in general, in which individual doses of a total amount of a generic substance or product are required to be selectively delivered.

The object of the present invention is to provide a support of the type particularly indicated for a dispenser of the type controlled by an equipment having a particularly simple structure, being particularly easy to manufacture and user-friendly, as well as having an enhanced functionality. A further object of the invention is to provide such a support that is particularly advantageously when used in combination with packaged substances of the so-called blister type. A further object of the invention is to provide a blister package to be advantageously used in combination with said support.

One or more of these objects is achieved, according to the present invention, by a support for a plurality of separate doses of deliverable substances, particularly washing agents, as well as a blister package having the characteristics as set forth in the annexed claims, which are an integral part of the descriptive contents of this patent application.

Further objects, characteristics and advantages of the present invention will appear from the detailed description below and the annexed drawings, which are merely provided by way of illustrative and non-limiting example, in which:

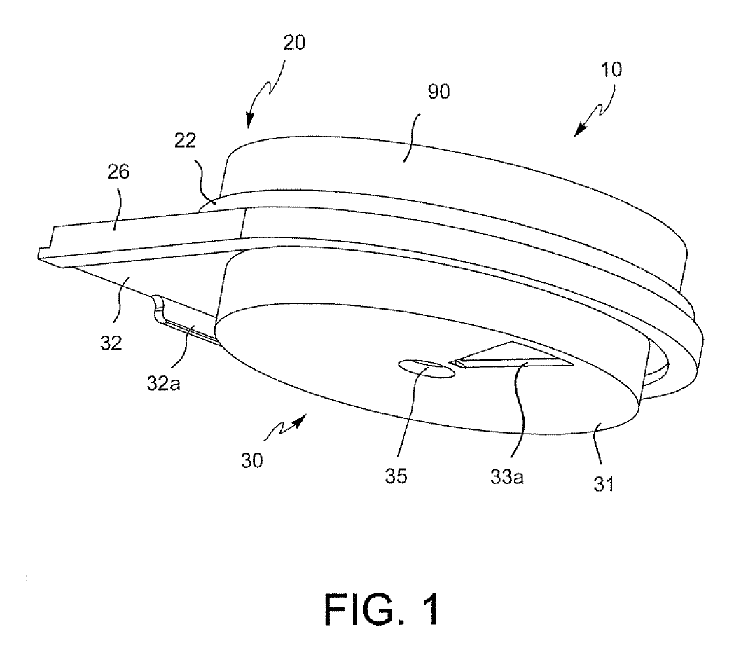

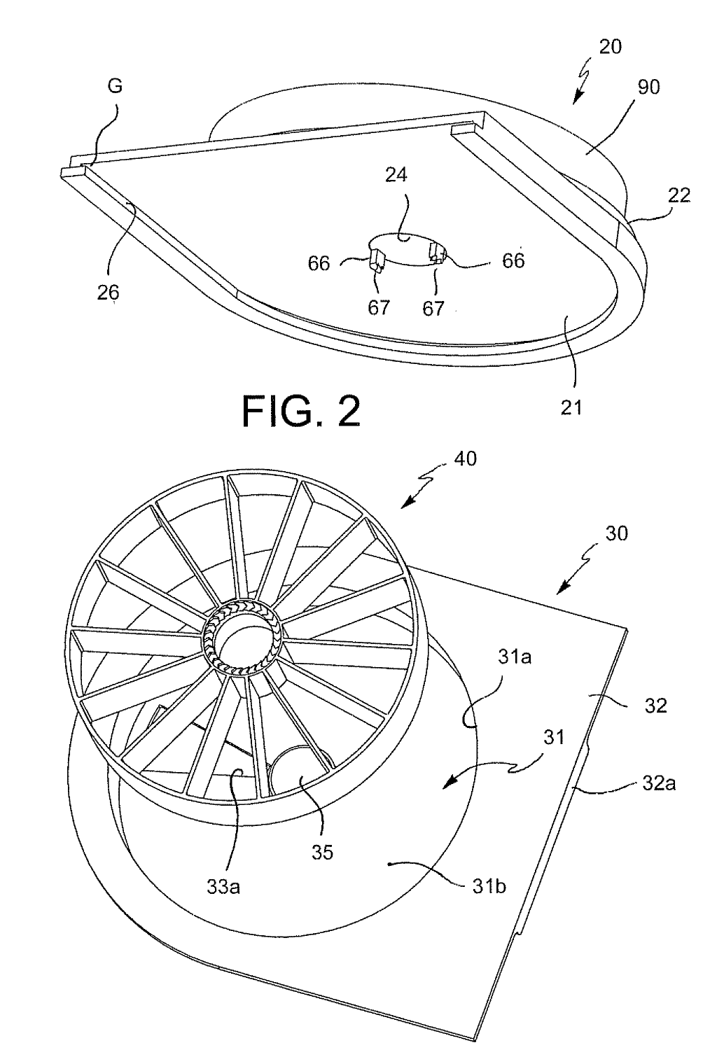

FIGS. 1 and 2 are a perspective view and a partially exploded view of a dispenser using a support for doses of substances or products according to the invention, respectively;

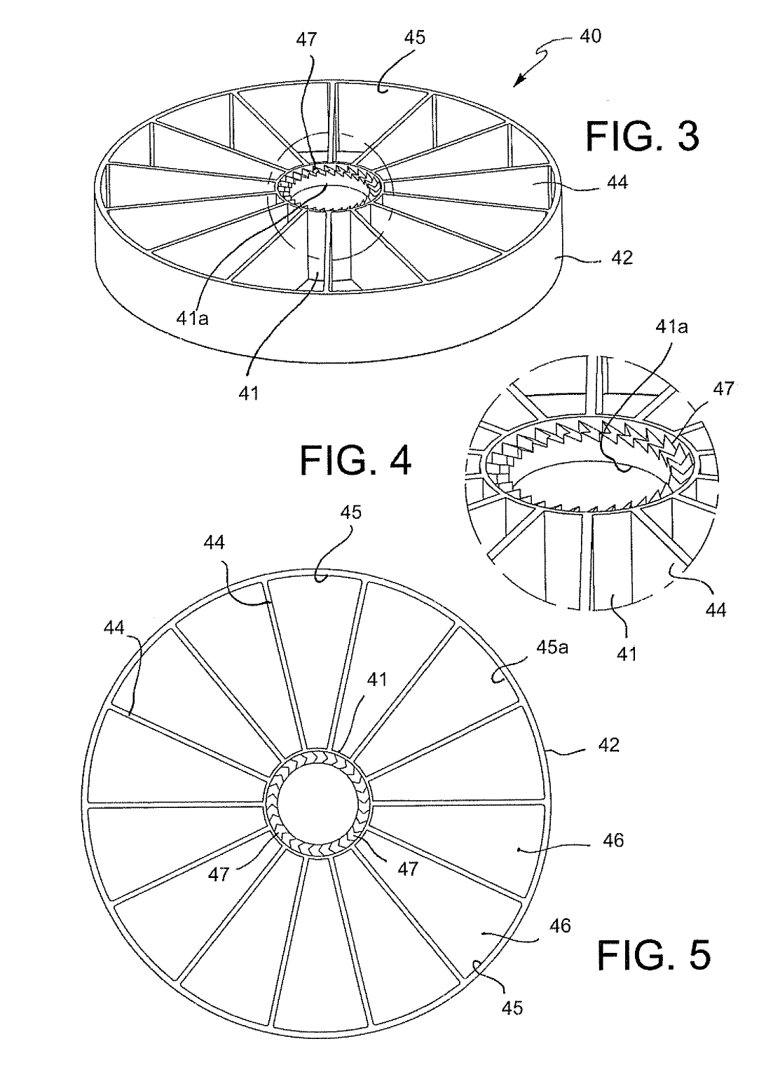

FIG. 3 is a perspective view of a first possible embodiment of a support according to the invention;

FIG. 4 is a detail of FIG. 3, in higher scale;

FIG. 5 is a plan view of the support in FIG. 3;

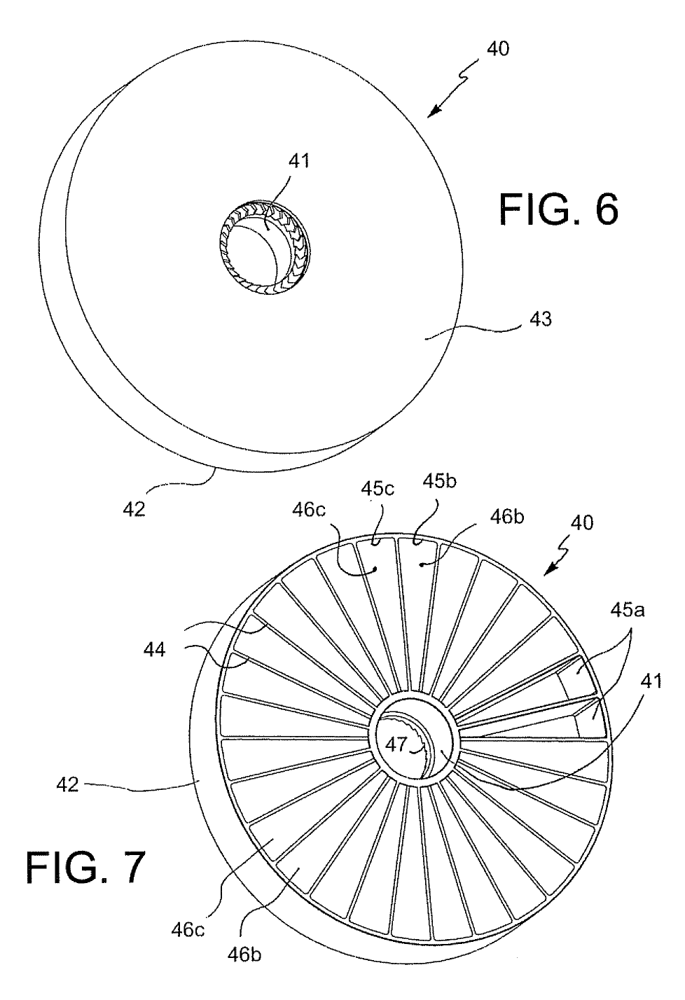

FIG. 6 is a perspective view of a first possible variant embodiment of the support in FIG. 3;

FIG. 7 is a perspective view of a second possible variant embodiment of the support in FIG. 3;

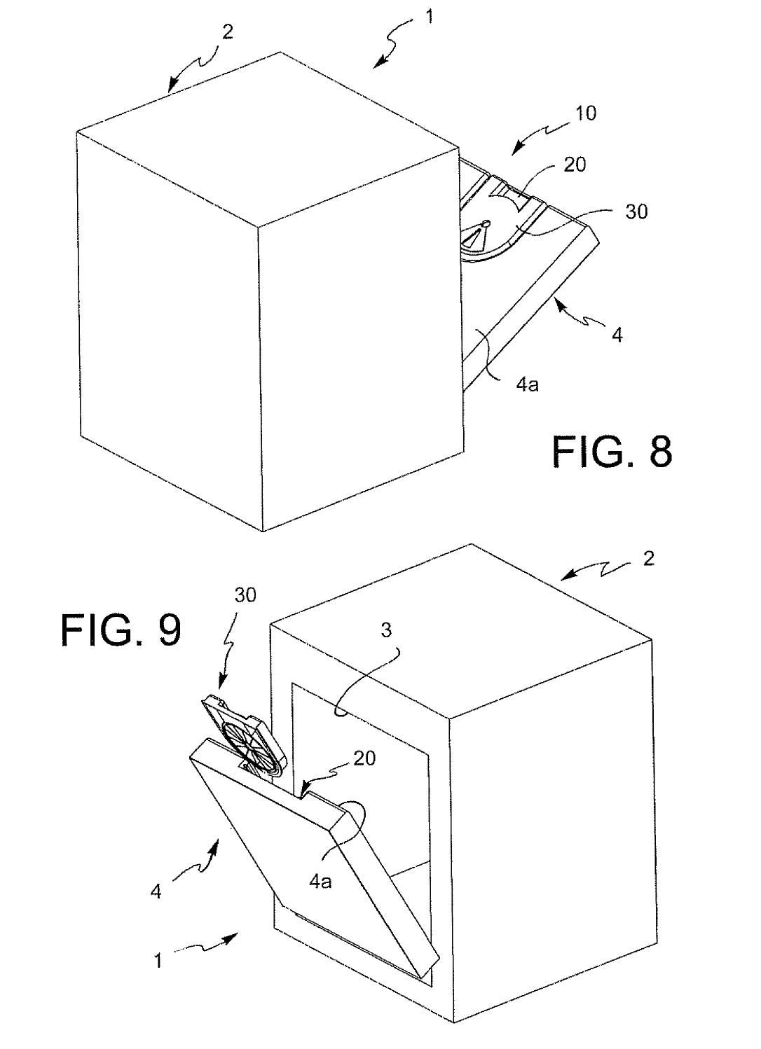

FIGS. 8 and 9 are perspective schematic views of a user equipment provided with a dispenser using a support provided in accordance with a second embodiment of the invention;

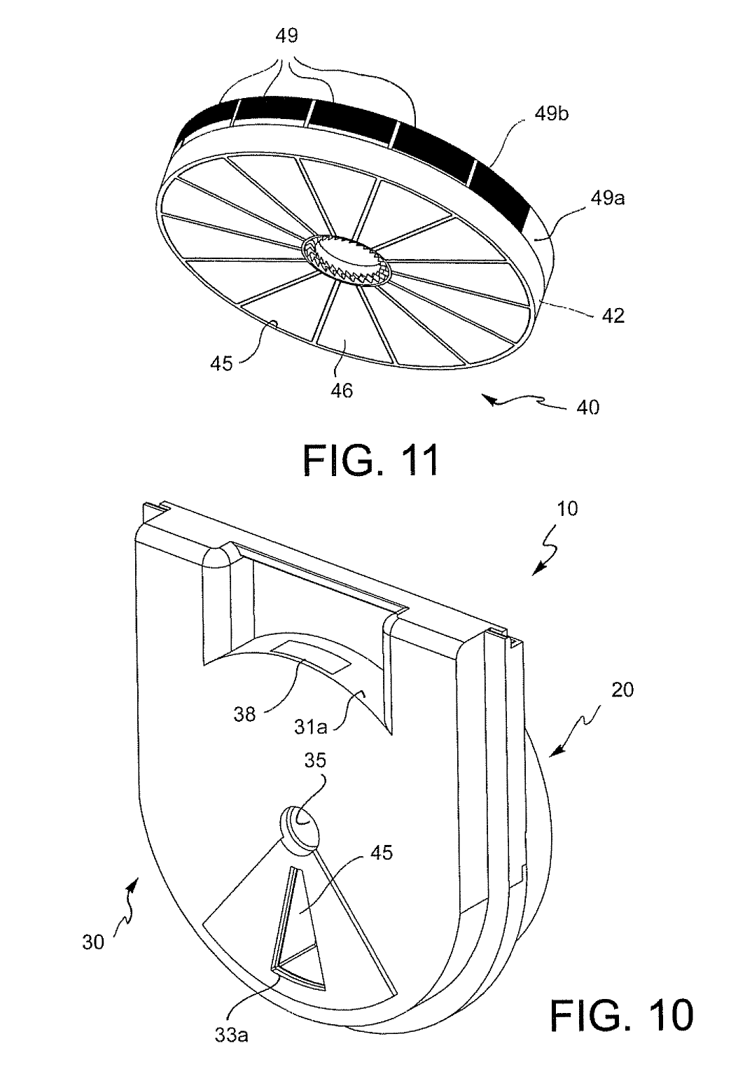

FIG. 10 is a perspective view of the dispenser of the equipment in FIG. 9;

FIG. 11 is a perspective view of the support provided in accordance with said second embodiment of the invention, which is used in the dispenser in FIG. 10;

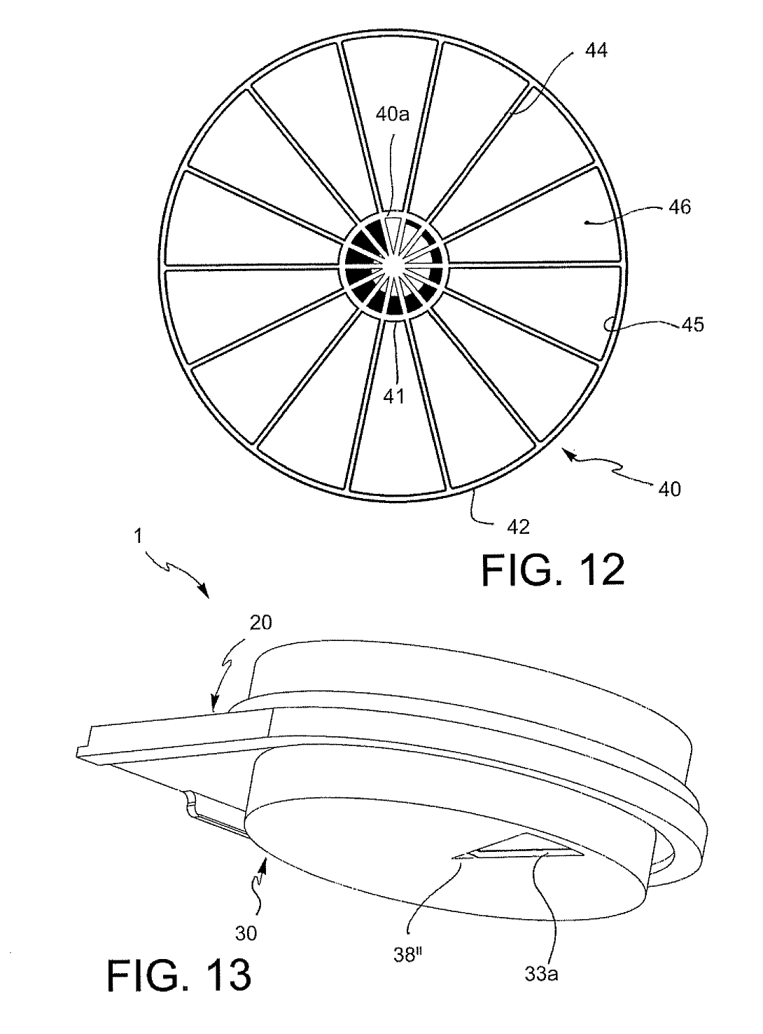

FIG. 12 is a variant embodiment of the support in FIG. 11;

FIG. 13 is a perspective view of a variant embodiment of the dispenser in FIG. 10, which can be used in combination with the support in FIG. 12;

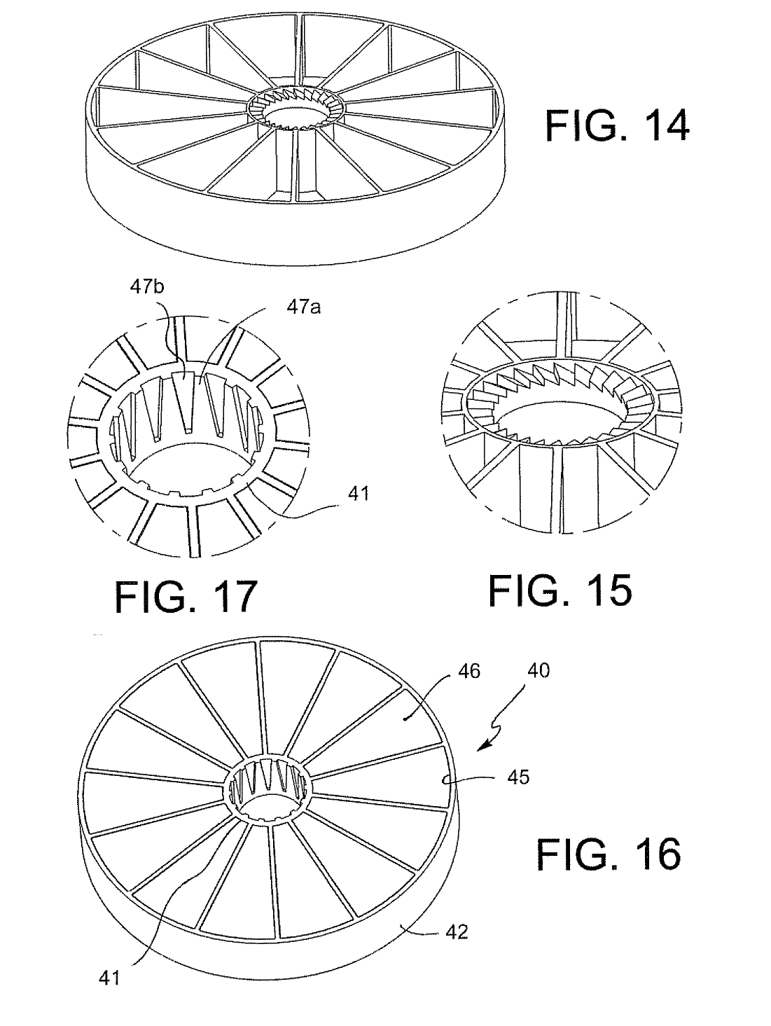

FIG. 14 is a perspective view of a support provided in accordance with a third embodiment of the invention;

FIG. 15 is a detail of FIG. 14, on an enlarged scale;

FIG. 16 is a perspective view of a support provided in accordance with a fourth embodiment of the invention;

FIG. 17 is a detail of FIG. 16, on an enlarged scale;

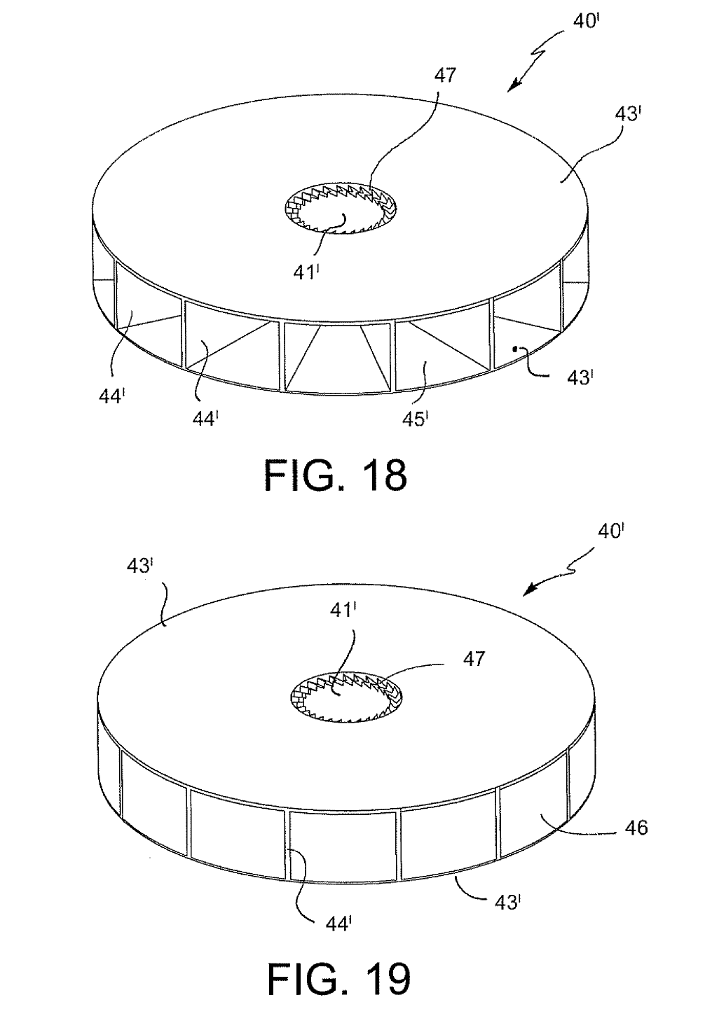

FIGS. 18 and 19 are two perspective views of a support provided in accordance with a fifth embodiment of the invention;

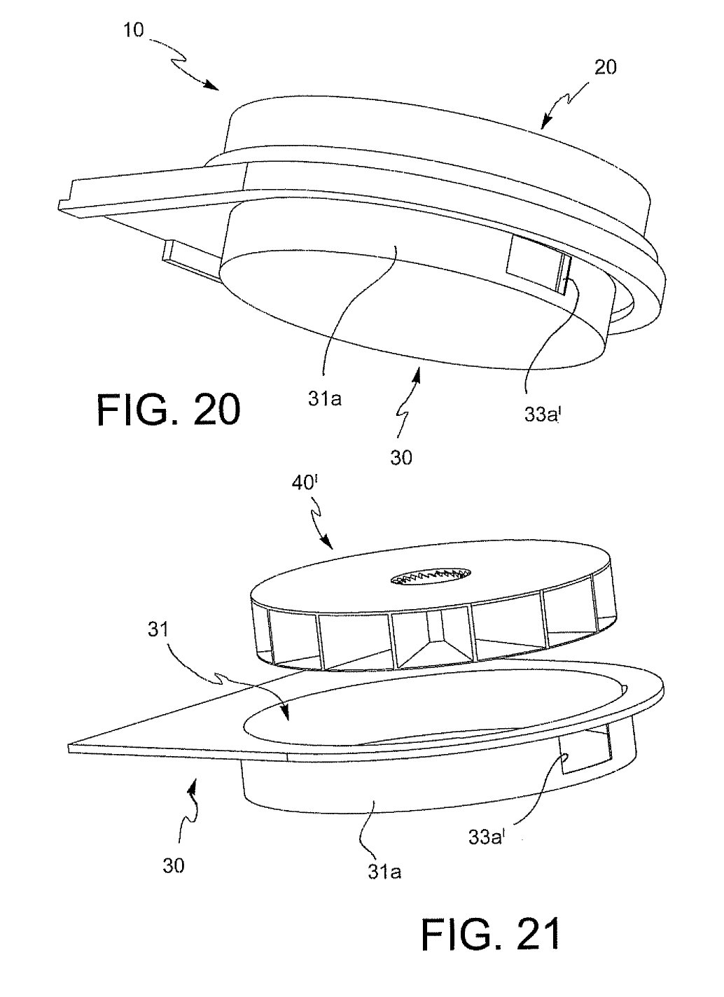

FIG. 20 is a perspective view of a dispenser that can be used in combination with the support in FIGS. 18 and 19;

FIG. 21 is a perspective view of a part of the dispenser in FIG. 20, with a support thereof according to the invention;

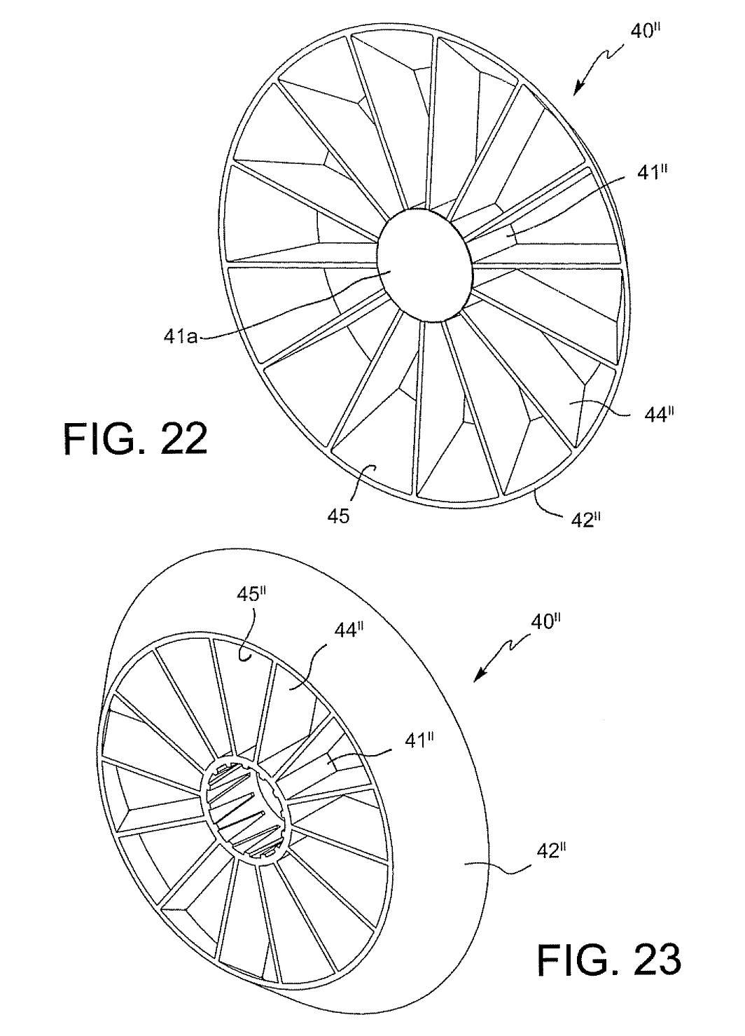

FIGS. 22 and 23 are two perspective views of a support provided in accordance with a sixth embodiment of the invention;

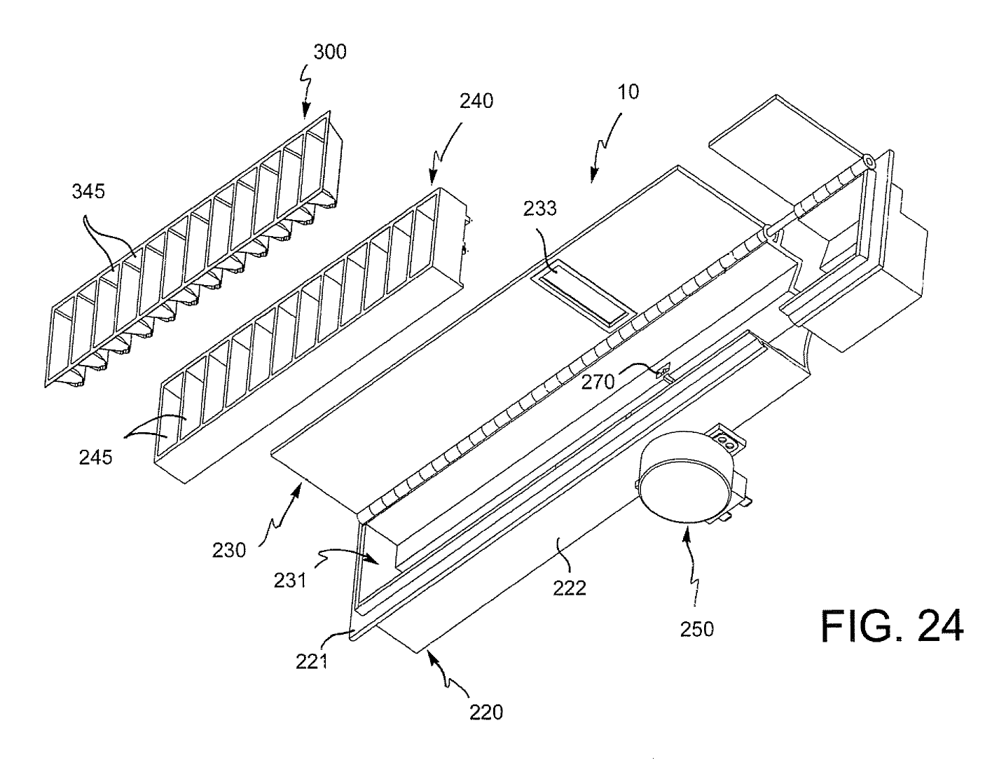

FIG. 24 is a partially exploded view of a dispenser using a support provided in accordance with a seventh embodiment of the invention;

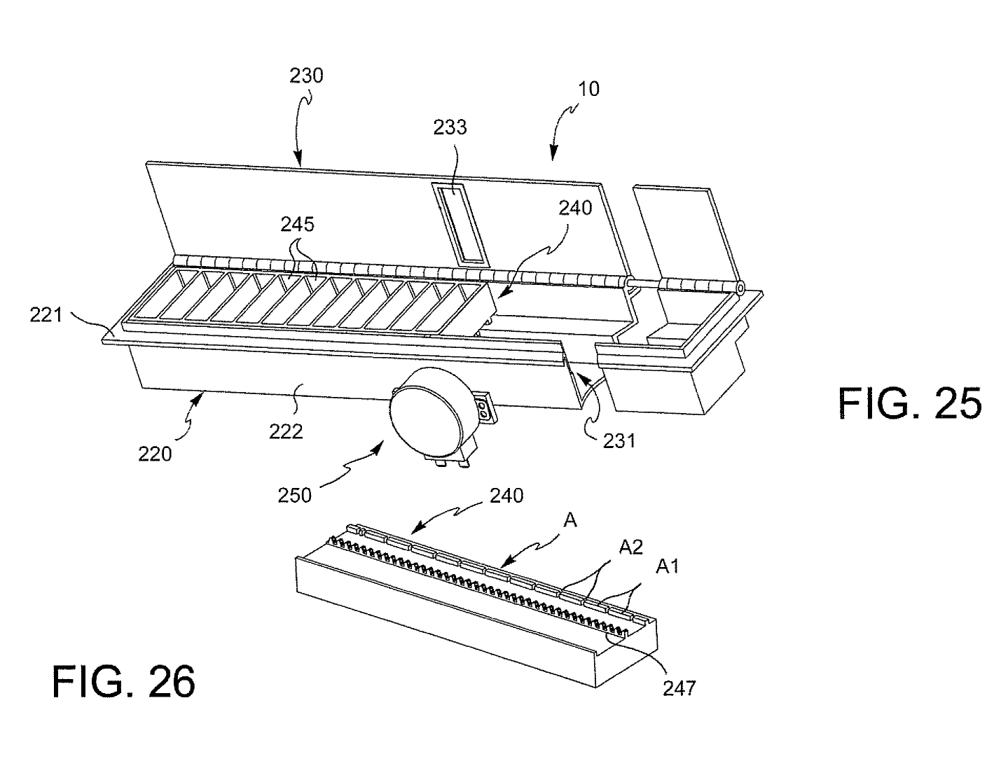

FIGS. 25 and 26 are perspective views, from different points of view, of the support seen in FIG. 24;

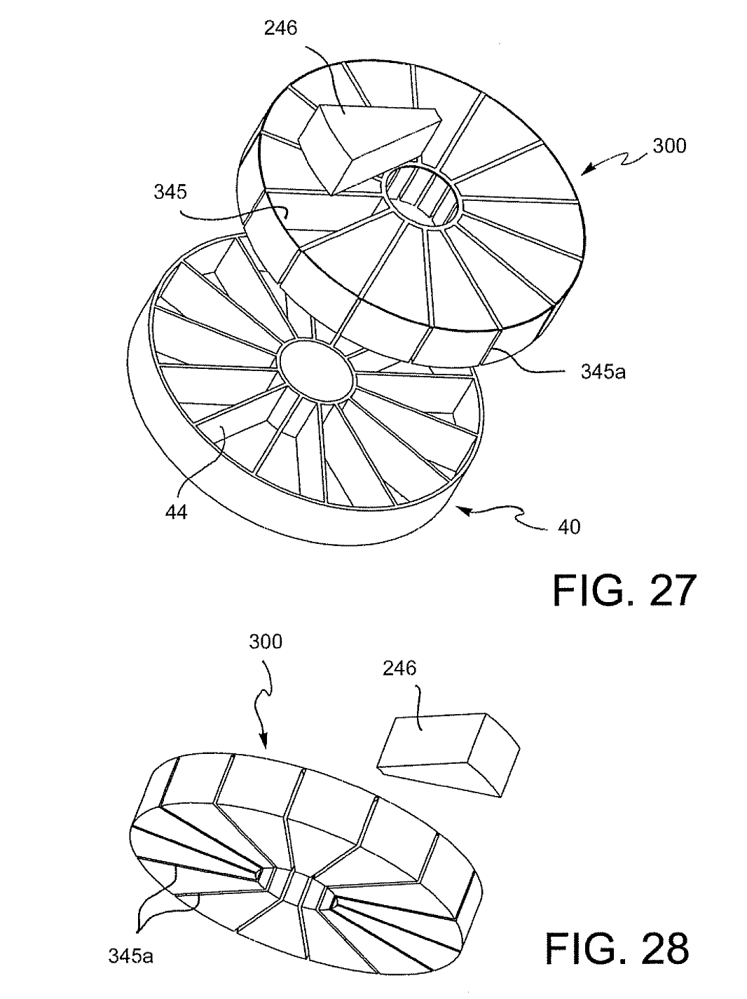

FIG. 27 is a perspective view illustrating the use of a support according to the first embodiment in combination with a respective blister package of substances according to the invention;

FIG. 28 is a perspective view of the blister package seen in FIG. 27;

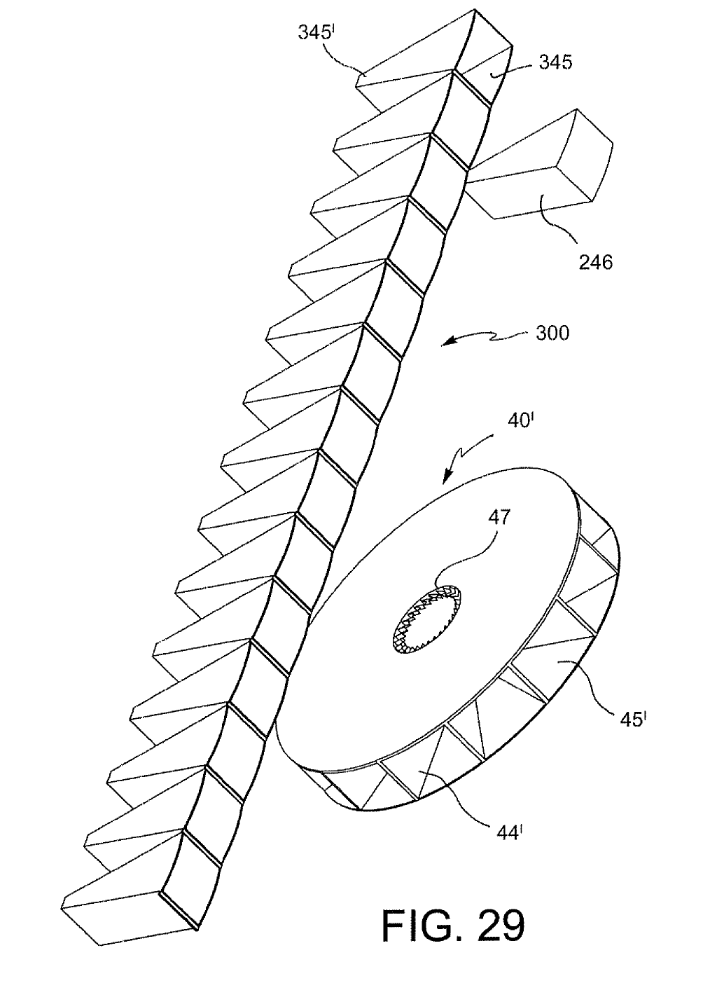

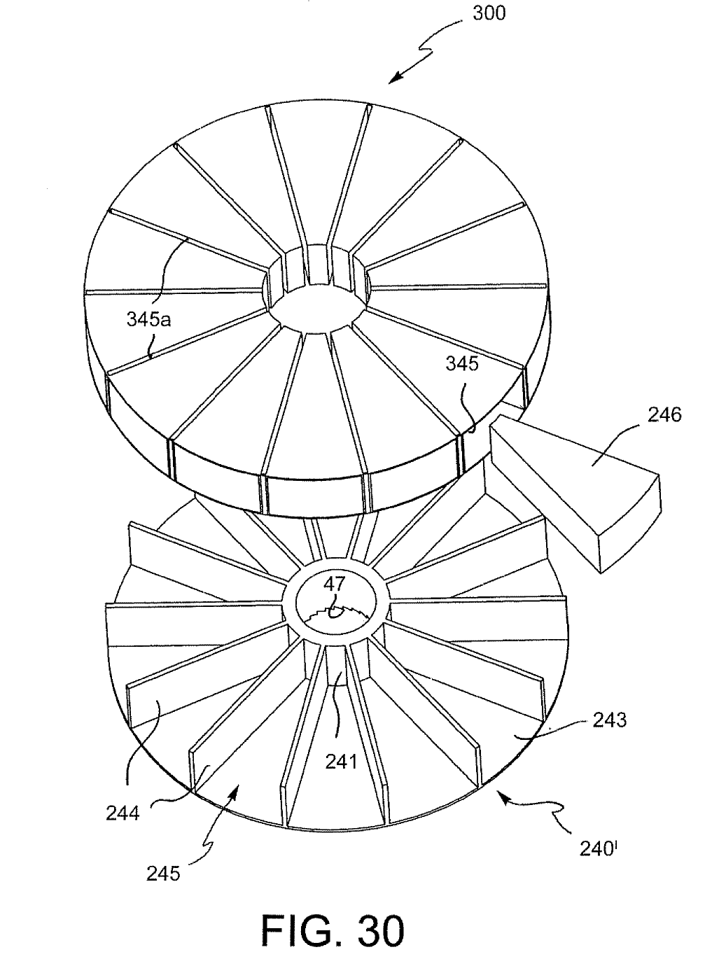

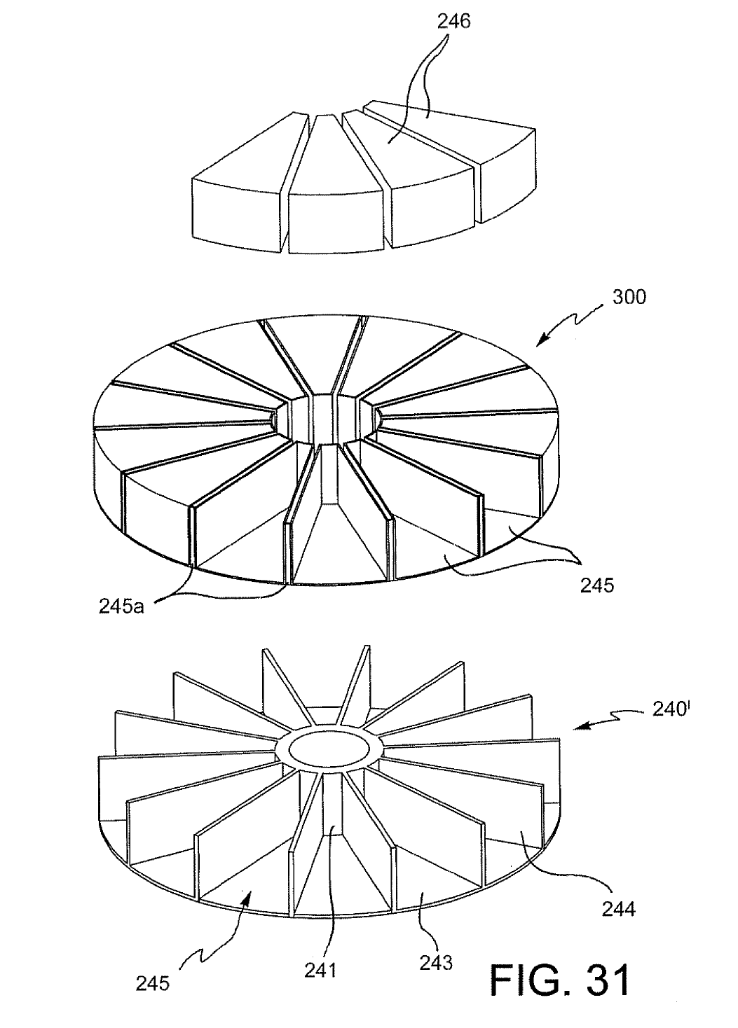

FIG. 29 is a perspective view illustrating the use of a support according to the fifth embodiment in combination with a relative blister package of substances according to the invention;

FIGS. 30 and 31 are perspective views illustrating an eighth embodiment of the support according to the invention, for respective blister packages of substances;

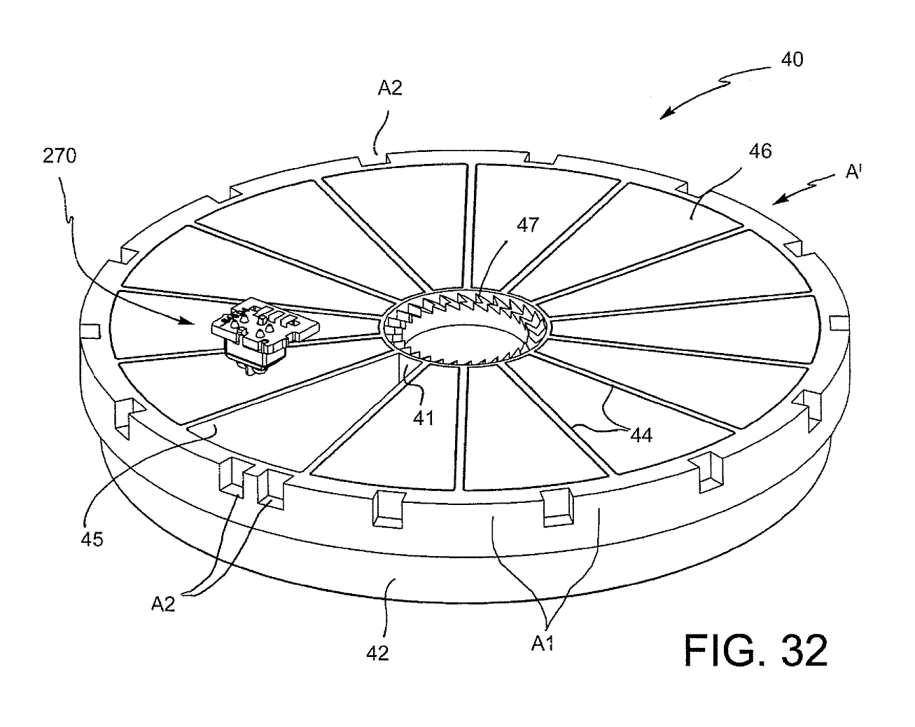

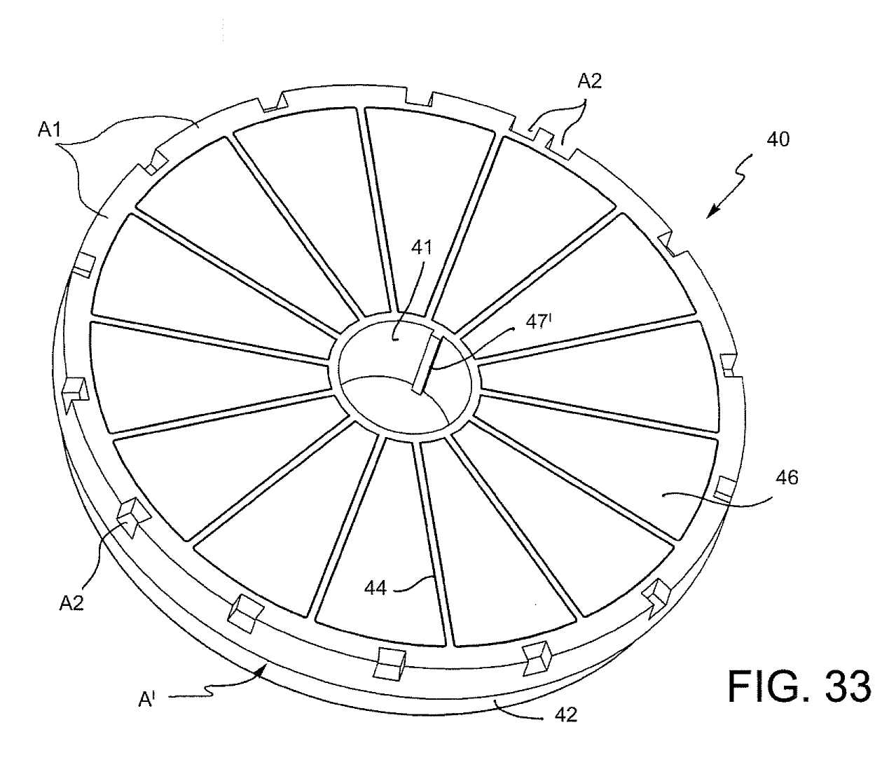

FIG. 32 is a perspective view of a support provided in accordance with a ninth embodiment of the invention;

FIG. 33 is a perspective view of a variant embodiment of the support in FIG. 32;

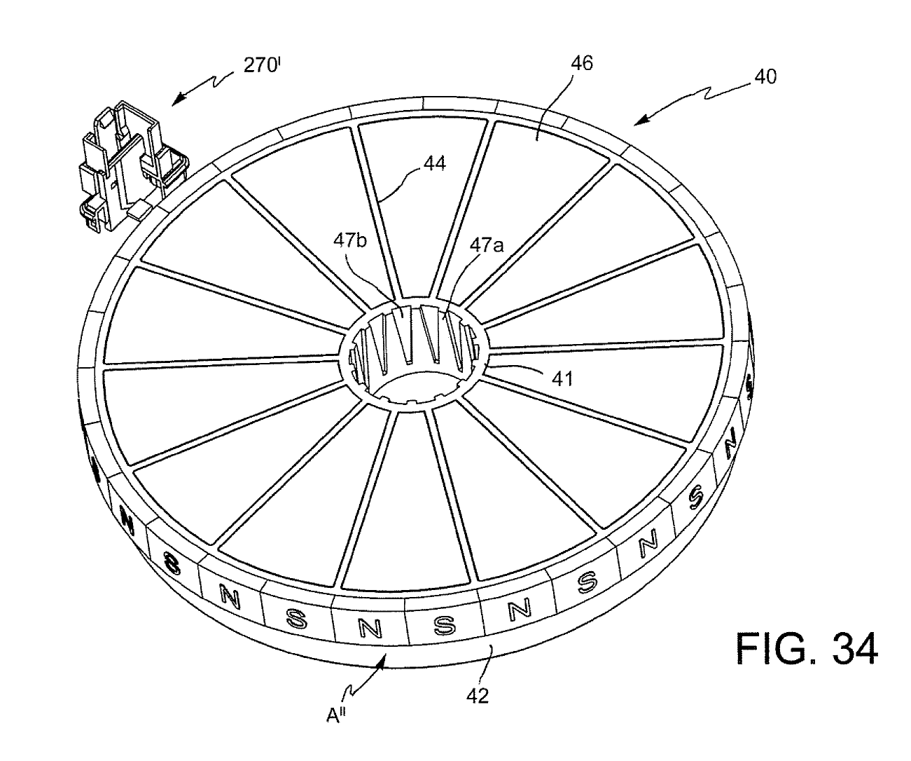

FIG. 34 is a perspective view of a support in accordance with a tenth embodiment of the invention;

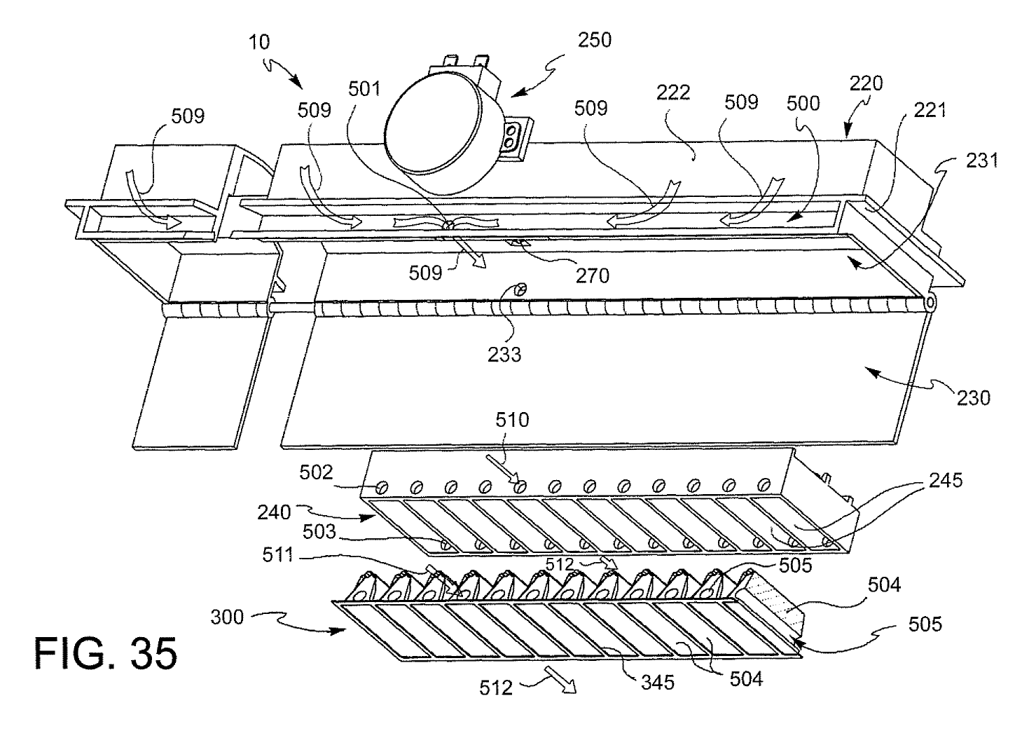

FIG. 35 shows a partially sectioned cut-away axonometric view of a further embodiment of dispenser using a support according to the invention;

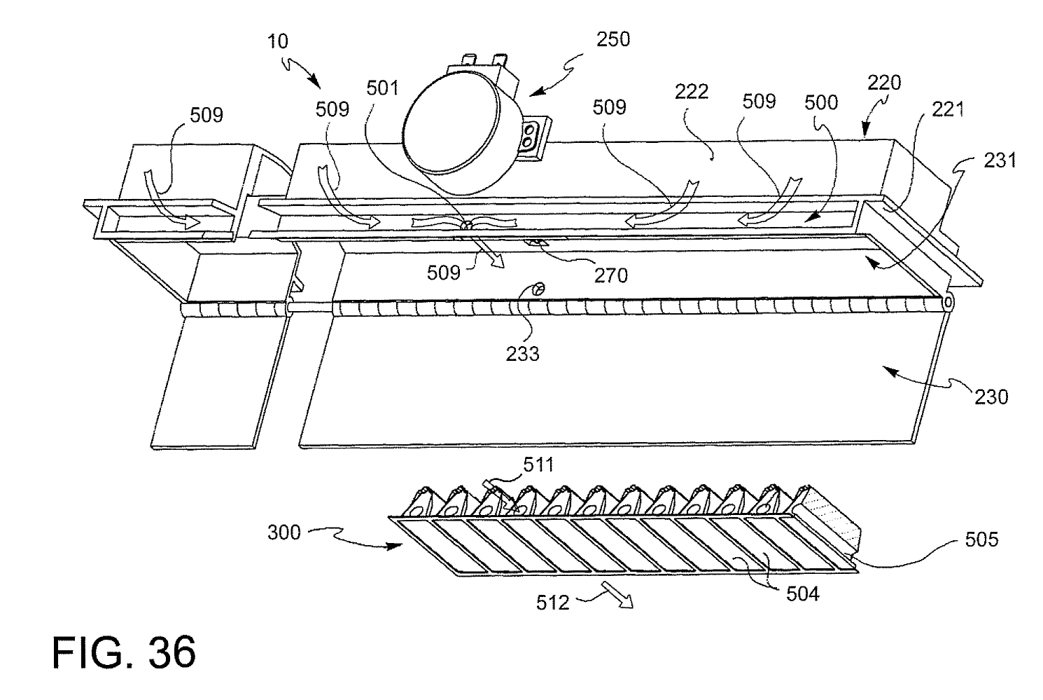

FIG. 36 shows a partially sectioned cut-away axonometric view of a still further embodiment of dispenser using a support according to the invention;

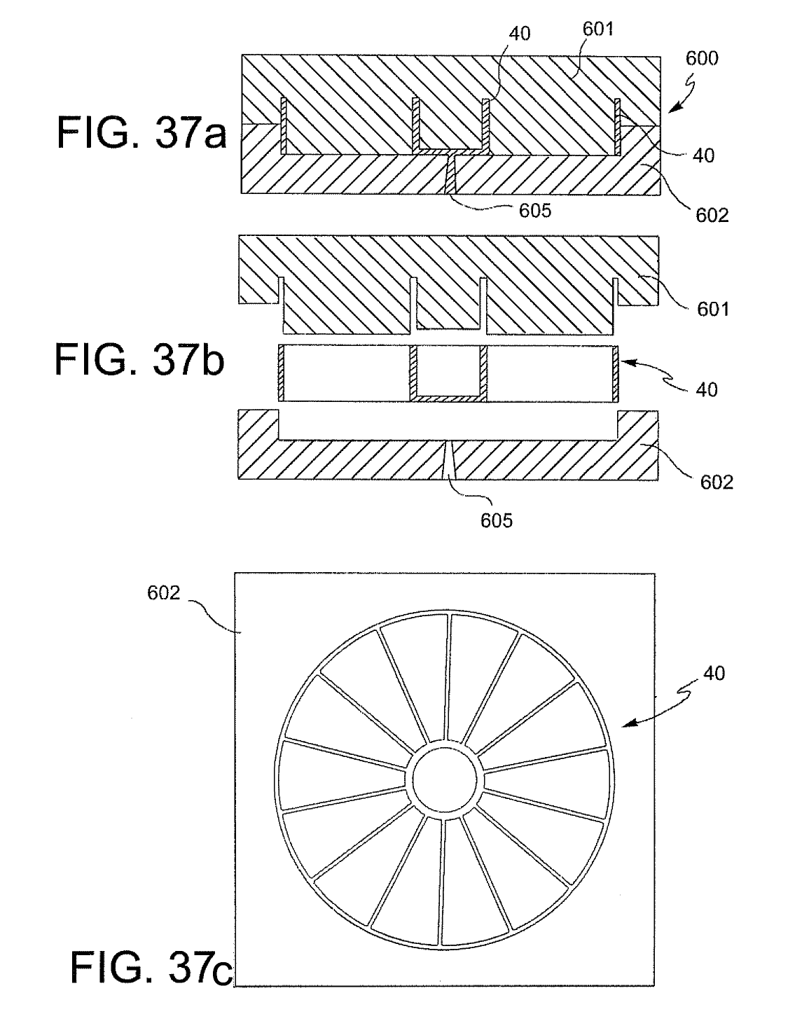

FIGS. 37a, 37b and 37c show three steps of a method for manufacturing a support according to an embodiment;

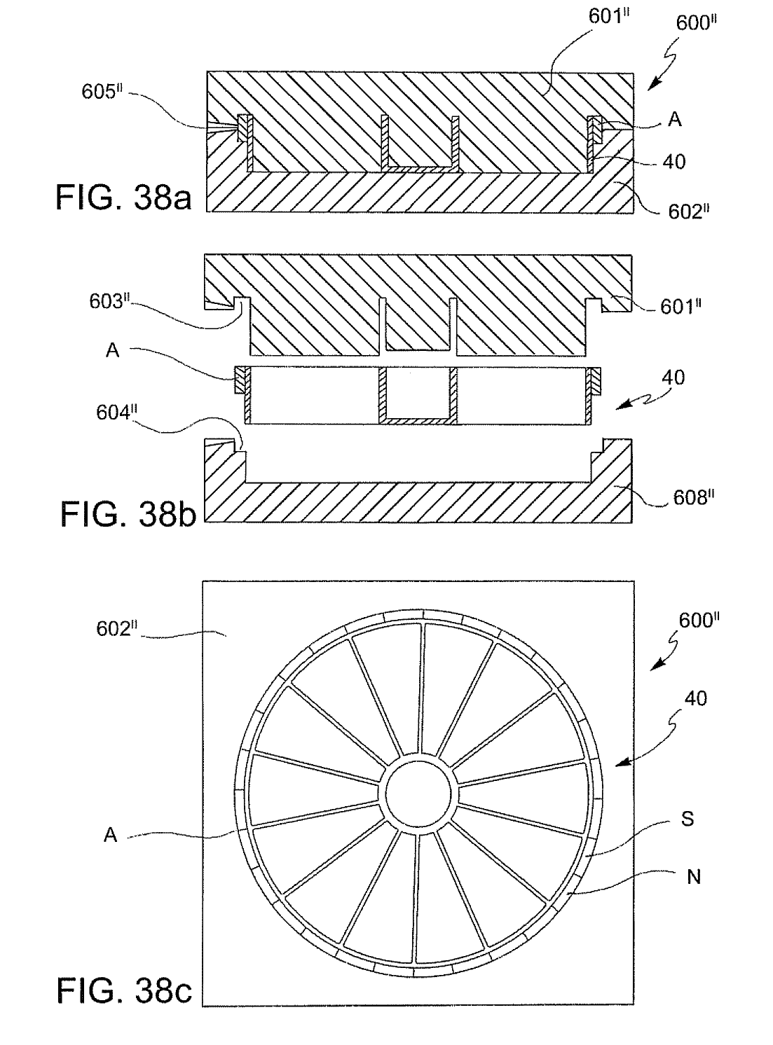

FIGS. 38a, 38b and 38c show three steps of a further method for manufacturing a support according to a further embodiment;

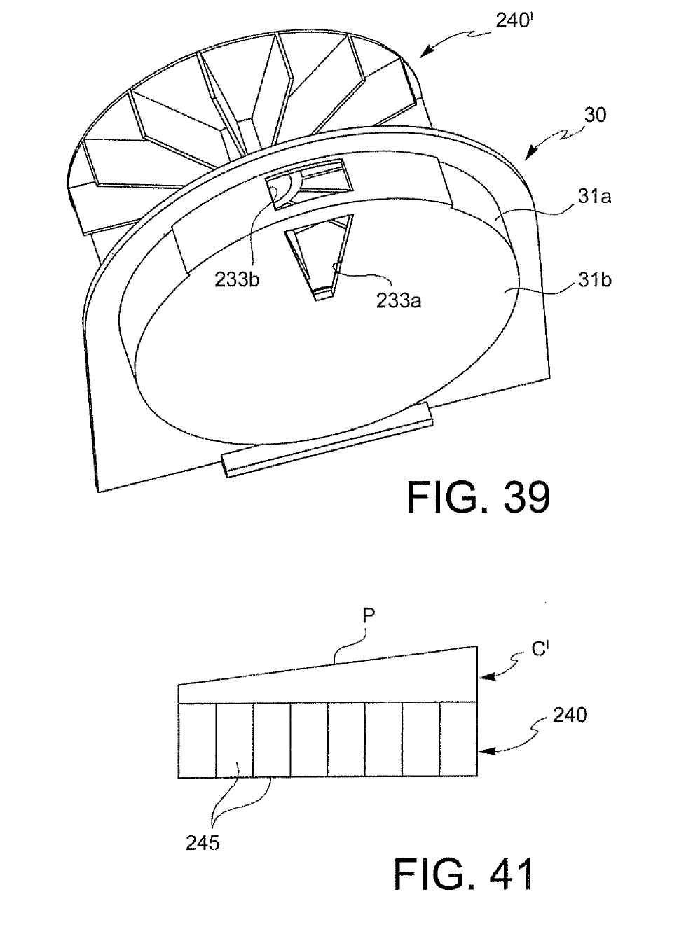

FIG. 39 is a cut-away perspective view of a part of a dispenser and a support according to a further embodiment;

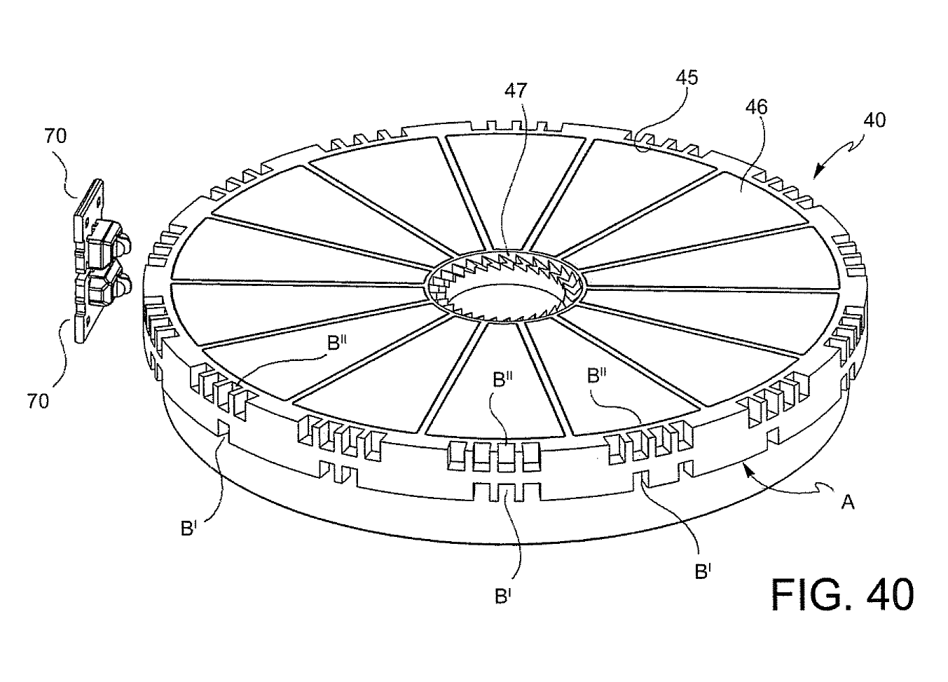

FIG. 40 is a perspective view of a variant embodiment of a support for a dispenser according to the invention;

FIG. 41 is a schematic and simplified illustration of a support for use in a dispenser, and arranged to co-operate with a detecting system or analogue transducer;

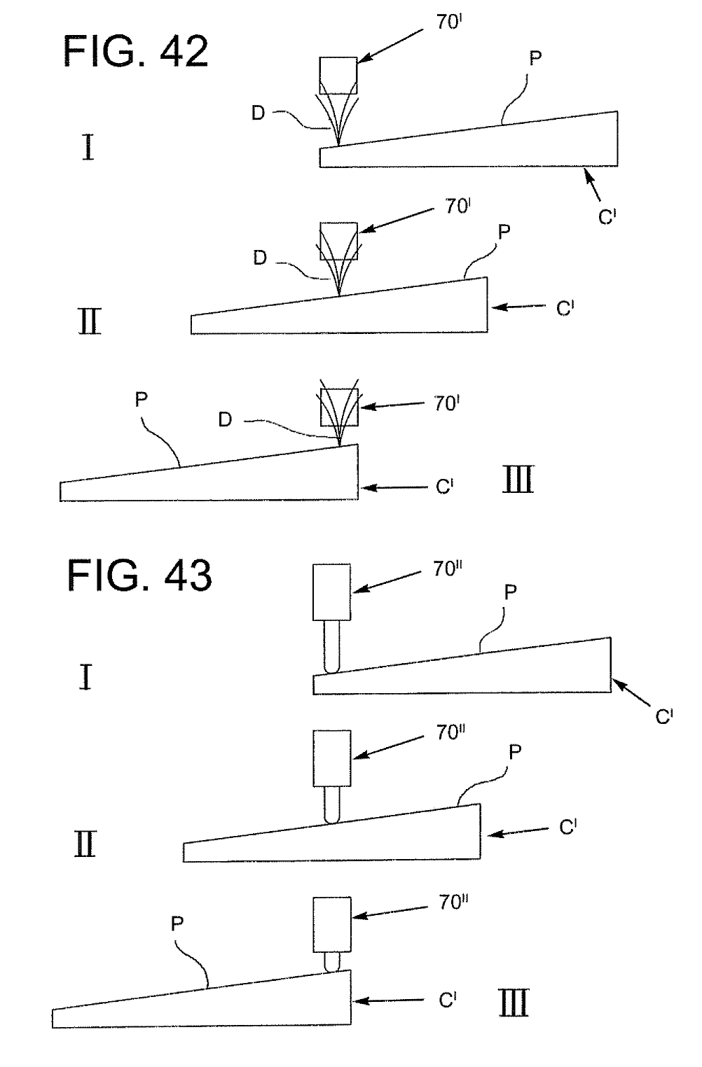

FIGS. 42 and 43 are schematic and simplified illustrations of the operative principle of two detecting systems or analogue transducers; and

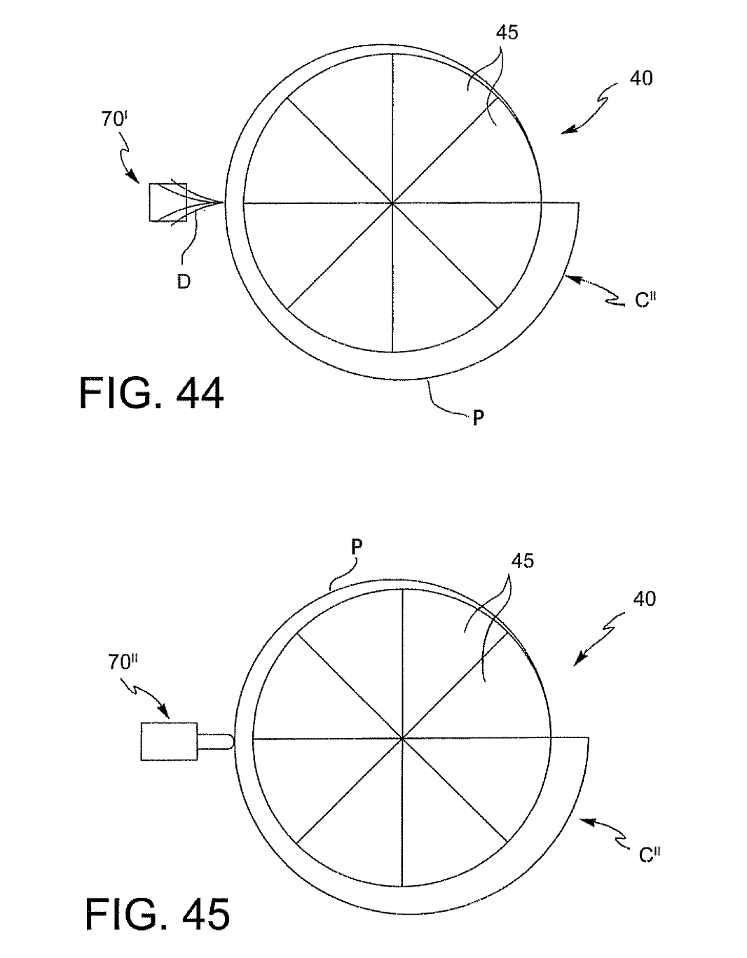

FIGS. 44 and 45 are schematic and simplified illustrations of a support for use in a dispenser, in combination with first and second detecting systems or analogue transducer, respectively;

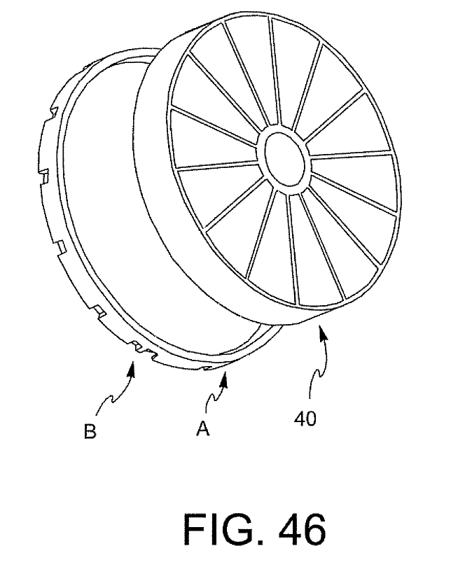

FIG. 46 is an exploded view of a support for washing substances that is provided in accordance with yet another embodiment;

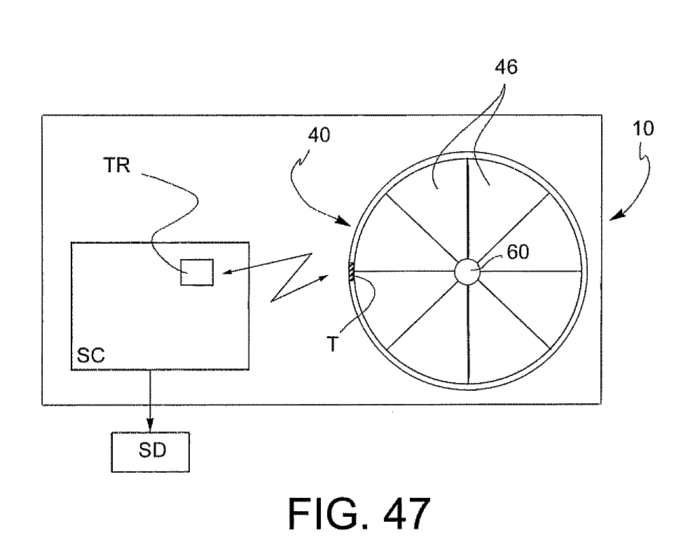

FIG. 47 is a simplified block diagram of a further inventive solution.

In accordance with a first general embodiment, a support for at least one dose of deliverable substance, particularly, a washing agent is arranged to be operatively coupled to a dispenser. This dispenser 10 is of the type comprising an actuating system 66, 67; 250 and a dispenser body 20, 30; 220, 230, having a positioning region 31; 231 for the support 40; 40′; 40″; 240; 240′ and a delivery opening 33a; 33a′; 233.

Said support 40; 40′; 40″; 240; 240′ is intended to be either coupled to or inserted within the positioning region 31; 231 of the dispensing device 10, such that a relative movement between the support 40; 40′; 40″; 240; 240′ and at least one part 30 of the dispenser body 20, 30; 220, 230 that is caused by the actuating system 66, 67; 250 allows selectively delivering at least one dose 46; 246.

Said support 40; 40′; 40″; 240; 240′ comprises reference or excitation means A; A′; A″; 49, 49a, 49b, in a predefined position relative to the at least one dose 46; 246 and configured to provide and/or obtain, following said relative movement between the support 40; 40′; 40″; 240; 240′ and at least one part 30 of the dispenser body 20, 30; 220, 230, a piece of information (including a figure).

Preferably the piece of information is representative of at least one of:
an amount of substance doses 46; 246 provided within the support 40; 40′; 40″; 240; 240′,
a condition and/or a position and/or a movement of the support 40; 40′; 40″; 240; 240′ within the positioning region 31; 231.

In accordance with a further general embodiment of the present invention, a support for at least one dose of deliverable substance is arranged to be operatively coupled to a dispensing device. Advantageously, this dispenser 10 is of the type comprising an actuating system 66, 67; 250 and a dispenser body 20, 30; 220, 230, having a positioning region 31; 231 for the support 40; 40′; 40″; 240; 240′ and a delivery opening 33a; 33a′; 233.

In accordance with an embodiment, said support 40; 40′; 40″; 240; 240′ is intended to be either coupled or inserted within the positioning region 31; 231 of the dispensing device 10, such that a relative movement between the support 40; 40′; 40″; 240; 240′ and at least one part 30 of the dispenser body 20, 30; 220, 230 that is caused by the actuating system 66, 67; 250 allows selectively delivering the at least one dose 46; 246.

Advantageously, said support 40; 40′; 40″; 240; 240′ comprises transmission means 47; 47′; 47a, 47b; 247 that are configured to co-operate in a reliable manner with the actuating system 66, 67; 250 of the dispenser 10.

In accordance with a yet further general embodiment, a support for at least one dose of deliverable substance is arranged to be operatively coupled to a dispensing device. Advantageously, this dispenser 10 is of the type comprising an actuating system 66, 67; 250 and a dispenser body 20, 30; 220, 230, having a positioning region 31; 231 for the support 40; 40′; 40″; 240; 240′ and a delivery opening 33a; 33a′; 233, said dispenser being fastened in a non-separable manner by a device suitable to receive said deliverable substance that is delivered from said dispenser.

Said support 40; 40′; 40″; 240; 240′ is intended to be either coupled to or inserted within the positioning region 31; 231 of the dispensing device 10, such that a relative movement between the support 40; 40′; 40″; 240; 240′ and at least one part 30 of the dispenser body 20, 30; 220, 230 that is caused by the actuating system 66, 67; 250 allows selectively delivering the at least one dose 46; 246.

Advantageously, said at least one dose of deliverable substance is, at least at the beginning of the delivery, firmly fastened to said support such that dissolving means can flow to said support and at least partially dissolve said dose and flow out together with the part of dissolved dose from said delivery opening 33a; 33a′; 233.

In accordance with an embodiment, a dispenser of substances for an user equipment is schematically illustrated in FIG. 1. In the embodiments illustrated below, which relate to a preferred field of application of the invention, the dispenser is intended to deliver washing agents in a domestic dish-washing machine.

The dispenser, generally designated as 10, is intended to be securely mounted to one of the walls defining the washing chamber of the dish-washer, such as the so-called “double door” or inner wall of the machine door.

As can be seen also with reference to FIGS. 2 and 3, the dispenser 10 comprises a stationary body 20 and a moving body 30, defining an housing for a support there between, such as for a plurality of separate doses of substances to be delivered according to the invention. In this exemplary embodiment and several of the following ones, the support according to the invention is configured as a refill cartridge (herein below also defined simply as the “cartridge” or “refill”), designated as 40 and intended to contain an amount of at least one washing agent sufficient to carry out a plurality of washing cycles by the dishwasher.

Electric actuating means, of any known type are associated with the stationary body 20, and are intended to be connected to the washing machine control system, in order to control the operation thereof. Transmission means are also associated with the body 20, and are arranged for transferring an actuating force generated by means of said actuating means to the cartridge 40, in order to cause a movement of the latter, such as an angular movement; as will be appreciated herein below, this movement is provided to allow the delivery of at least one dose of detergent contained within the cartridge 40, during a washing cycle carried out by the dish-washer.

The body 20 is intended to be sealingly fixed at a respective opening defined in the desired wall of the dish-washer tank; particularly, a first portion of the body 20, protected by a lid 90, is intended to be housed within a gap defined between the outer structure of the dish-washer and the tank thereof, whereas a second portion of the body 20 is intended to result either exposed or housed within the tank, and the moving body 30 is associated therewith; in the embodiment illustrated herein, said second portion of the body 20 defines a seat for slidably housing the moving body 30, which is substantially configured as a drawer.

The stationary body 20 comprises a main or base wall 21, a guide G departing from the lower part thereof, which is suitable to slidably receive a respective peripheral portion of the moving body 30 of the dispenser 10.

As said above, the moving body 30 is substantially configured as a sliding drawer, which has a lower housing portion, designated as 31, substantially cylindrical, integral to an upper flange-shaped portion 32, of which the edge is suitable to slide within the guide G (it should be noted that terms like “upper” and “lower” are to be intended with reference to the annexed figures, and must be not considered as limiting the invention).

The housing portion 31 is defined by a circumferential wall 31a, a bottom wall 31b, a delivery through opening 33a being defined within the latter.

The housing portion 31 of the moving body 30 is intended to accommodate the cartridge 40, which is arranged for containing an amount of washing agent sufficient for carrying out several washing cycles by means of the dish-washer. In the case illustrated herein, the refill cartridge has a generally flattened cylindrical body, a plurality of compartments or receptacles being defined therein for respective doses of the washing agent.

As may be seen also in FIG. 3-5, the body of the cartridge 40, e.g. made of plastics material, comprises a central tubular portion 41 and a peripheral cylindrical wall 42. In a possible variant embodiment, shown in FIG. 6, the body of the cartridge 40 may also include a closure wall at an axial end thereof, designated as 43, which however is not strictly required for the operation of the dispenser 10. The wall 43, when provided, has preferably a thin configuration and/or is made of a transparent material (this wall 43 may consist for example of an additional element welded thereto, or be an integral part of the cartridge 40, or alternatively a part of a protective envelope). In the simplest implementation, said wall 43 is, however, not provided, the two opposite faces of the cartridge 40 being thus both open.

A plurality of walls or radial partition walls 44 extends between the central tubular portion 41 and the peripheral wall 42, which define a series of receptacles or alveoli 45, respective doses of a substance in solid form, such as a washing agent or detergent, being contained therein, some of them are designated as 46 in FIG. 5; in the case illustrated herein, the receptacles 45 are segmental, having a plan profile substantially equal to that of opening 33a of body 30; the doses 46 can be configured as tablets of a shape matching the one of the receptacles 45, inserted within the latter with moderate interference; alternatively, a powder detergent can be either compacted or sintered, or a settable liquid detergent can be injected or moulded during the manufacture of the cartridge 40, within the various receptacles 45; in any case, the detergent doses are preferably arranged within the receptacles 45 such that they cannot escape there from only by gravity.

When both faces of the cartridge 40 are open, the receptacles 45 are also axially open at the longitudinal ends thereof. In view of the above, preferably, the cartridge 40 is packaged such that said faces, and accordingly the receptacles 45 containing the detergent, are closed by means of respective films or protection lids, at least the film or lid being on the lower face of the cartridge 40 is intended to be removed before the cartridge is inserted within the dispenser 10. In an alternative embodiment such film(s) could be of a water-soluble plastics material, such as polyvinyl alcohol, to be dissolved in use. When the wall 43 is provided, the receptacles 45 are, obviously, open only on the opposite side, and the cartridge will be packaged with an individual removable or dissolvable film or lid, at the face opposite said wall 43.

The central tubular portion 41 of cartridge 40 is provided, in the end area thereof proximate to the upper face thereof, of means for coupling with respective actuating members of the dispenser 10, particularly in a separable manner; in the example illustrated herein, these coupling means consist of a ring gear, i.e. a sequence of teeth 47 arranged along a circumference; as can be seen in FIG. 4, the teeth 47 lie within the tubular portion 41, which is purposely provided with an inner circular flange, designated as 47a, said toothed ring being formed thereon. In the embodiment illustrated herein, the teeth are substantially saw teeth, with each tooth 47 being defined by a ramped upper surface and a substantially vertical front surface; in the instant case, furthermore, said front surface of the teeth 47 is not planar, but has a V-shaped profile in a plan view, which is formed by two diverging wall tracts, i.e. with a substantially herringbone front profile of the teeth (see for example FIG. 5).

The transmission means of the dispenser 10 comprise a transmission member, which is supported within a cylindrical seat 24 of the body 20 such as to be capable of moving in an angular manner; this member includes projections 66, carrying teeth 67 at the ends thereof, which are intended to co-operate with the teeth 47 of cartridge 40.

For use, the cartridge 40 is positioned within the housing portion 31 of the moving body 30. At least one of the receptacles of the cartridge 40, designated as 45a in FIG. 5, is preferably not provided with detergent. The proper operation of the dispenser 10 requires that the empty receptacle 45a must be first brought to the opening 33a; for this purpose, the user rotates the cartridge 40 within the housing 31 with his/her hand. At this stage, the moving body 30 is closed, i.e. caused to slide along guide G.

During the operation of the dispenser 10, the teeth 67 are engaged with the teeth 47 of the underlying tubular portion 41 of cartridge 40, thus causing the rotation of the latter.

Due to the engagement between the teeth 67 and 47, the rotation of the transmission member carrying the projections 66 defines an angular movement of the cartridge 40, which is aimed at bringing to the opening 33a a receptacle 45 that is immediately adjacent the empty receptacle 45a (i.e. to cause a receptacle filled with detergent to face the opening 33a).

When a receptacle 45 is brought to the opening 33a, the respective dose of detergent 46 is cyclically impacted by a jet of washing liquid that is ejected by a rotary sprinkler, which is provided within the dishwasher chamber: thereby, a progressive dissolution of the washing agent is carried out, the latter being delivered towards the inside of the chamber.

In order to replace a spent (empty) cartridge 40, with the machine off-line, the user must remove the moving body 30 from the stationary body 20; the spent cartridge can be replaced with a new cartridge 40. The moving body 30 is then re-closed.

In the embodiment described above, the cartridge contains an individual detergent portion, which is intended to be delivered either during a same step of a washing cycle, or in different steps of a same cycle. In a possible alternative implementation, however, the cartridge can be configured to contain at least two detergent portions for one washing cycle.

This case is schematically illustrated in FIG. 7, wherein the cartridge 40 is provided with first receptacles, designated as 45b, alternated with second receptacles, designated as 45c, respectively containing first detergent portions 46b and second detergent portions 46c, respectively, being in solid form. In the example in FIG. 7, the individual receptacles 45b, 45c have an angular extent corresponding to half the angular extent of the sectors designated above as 45. Thereby, a first receptacle 45b will be first positioned, in order to deliver the first detergent portion 46b, and a second receptacle 45c will be then positioned at the opening 33a, in order to deliver the second detergent portion 46c.

FIG. 7 also illustrates the case of a cartridge 40 being provided with two empty receptacles 45a, adjacent to each other. It should be specified, however, that the provision of one or two receptacles 45a within the cartridge 40, which are not provided with detergent since the beginning, is not strictly required in order to implement the invention (all receptacles can be filled when a detergent dose is desired to be delivered from the very early steps of a washing cycle).

FIGS. 8 and 9 show an item of household equipment, embodied herein by a dishwashing machine generally designated as 1, having a structure 2 in the form of a cabinet, around a washing chamber 3. A front door 4 is associated with the structure 2, which door is of a drop-down type, i.e. hinged in the lower region thereof to the cabinet 2, such as to be capable of pivoting about a substantially horizontal axis. Sprinkler means is rotatably supported within the chamber 3. The sprinkler means is not shown; its concept and operation are known per se. The sprinkler means is intended to be supplied with a pressurized washing liquid, in order to direct a plurality of jets of this liquid to the dishes contained within suitable baskets of the dishwasher, also not shown herein.

In accordance with FIGS. 8 and 9, the dispenser 10 is adapted to be mounted to the inside panel 4a of door 4.

In FIG. 10, it can be seen how the moving body 30 is provided with, in the circumferential wall 31a of the cartridge housing, a transparent window, designated as 38. Through this window 38, which in the assembled condition of the dispenser 10 faces upwards, the user has the possibility of visually checking the residual amount of detergent doses contained within the cartridge 40, signaled by means of suitable indications or symbols.

A possible example of these indications can be seen in FIG. 11, where it can be seen how symbols are either recorded or impressed on the peripheral wall of cartridge 40, and which have the same area, each being at the circumferential periphery of a respective receptacle 45. In the instant case the cartridge 40 has fourteen receptacles, and has:
twelve symbols 49, with area formed by a region of a first colour, such as green, and a region of a second colour, such as red, which are indicative of the amount of available doses and the dose consumption level, respectively; practically, in the example, the symbols 49 are each formed by two superimposed rectangles, one green and the other red, where the heights of the two rectangles are different for the various symbols 49;
a symbol 49a, the area thereof being completely of the first colour (in the example, accordingly, a completely green rectangle of maximum height);
a symbol 49b, the area thereof being completely of the second colour (in the example, accordingly, a completely red rectangle of maximum height);

In this embodiment, the empty receptacle 45a is not provided and the symbols 49a and 49b are associated with immediately adjacent receptacles (different shapes and/or arrangement may be, however, adopted).

When the moving body 30 is loaded within the housing thereof, a new cartridge 40 must be manually rotated to a preset position, substantially in a similar manner as with the first embodiment; in said preset position, the green symbol 49a will be visible from the window 38, which indicates the maximum amount of available detergent doses; this symbol also facilitates the user during the operation of manual positioning the cartridge 40, since it also indicates the initial position in a visual manner.

The rotation of the cartridge 40 during the normal operation of the dispenser will cause the symbols 49 to be displayed through the window 38, with the green part becoming smaller and smaller, and the red part becoming greater and greater, in order to visually inform the user, in an intuitive manner, on the progressive reduction of the available washing agent doses; when the last detergent-containing receptacle 45 will be at the opening 33a, the receptacle 49b will be at the window 38, totally red, such as to inform the user that the cartridge 40 must be replaced.

The symbols 49, 49a, 49b in a predefined position relative to the receptacles 45 thus provide information on the amount of washing agent doses, following the relative movement between the cartridge and dispenser body.

Said symbols 49 can certainly be of any other type suitable to the purpose, graphic and/or alphabetic and/or numerical (for example, in form of decreasing numeration, such as to advise the user by means of a sort of “countdown”, or with status indications, such as “full”, “empty”, etc.).

The above-cited symbols can be directly formed in the body of cartridge 40, such as during a moulding step of the latter, or can be impressed on already-formed elements—for example configured as one or more adhesive labels applied to said body.

FIGS. 12 and 13 show a possible alternative embodiment providing colour signalling intended to allow visual checking the amount of detergent doses provided within the cartridge 40.

In this embodiment a transparent window 38″ is provided in the body 30, at the detergent-delivery opening 33a, which window faces a bottom wall 40a of the central tubular portion or hub of cartridge 40, whose circular elevation is depicted divided into sectors, each being aligned with—in effect an inwards extension of—a respective receptacle 45 of cartridge 40. Similarly to what has been described with reference to FIG. 11, two adjacent sectors are furnished completely in first and second colours respectively, such as green and red, while the remaining sectors include regions furnished in the two colours, progressively changing in their relative proportions.

When a filled cartridge 40 is in the starting position, the sector visible through the window 38″ is completely green. Also in this case, the subsequent controlled rotation of the cartridge 40 causes sectors with differently sized green and red regions to be sequentially displayed through the window 38″, such that the user is visually informed of the progressive decrease in the available doses of washing agent; when the last detergent-containing receptacle comes at the opening 33a, the completely red sector will be at the window 38″, such as to advise the user that the cartridge 40 must be replaced.

Of course, also in the version of FIGS. 12 and 13, the shapes and symbols associated with the various indication sectors provided on the wall 40a can be of any type suitable to the purpose, such as decreasing numeration.

The shapes of the teeth 47 of the cartridge 40 can also have a configuration other than that illustrated above, and may change as a function of the form of transmission system that has been selected for the dispenser 10.

FIGS. 14 and 15 show, for example, teeth 47 having a slightly different shape from the teeth of the embodiment in FIG. 3-5, and have, in this case, a rectilinear front profile, rather than herringbone profile; it should be noted that the teeth 47 may be in a different number and/or distributed in a different manner from that represented herein.

In FIGS. 16 and 17, a further possible embodiment of the means for engaging the cartridge 40 with the transmission means of the dispenser 10 is shown; which comprise in this case an alternating series of relief portions or projections 47b and cavities 47a defined in the inner surface of the central tubular portion or hub 41 of cartridge 40. Such an embodiment, in which said relief portions or projections and cavities preferably have a substantially triangle- or isosceles trapezium-shaped (i.e. ramped) profile, ensures that the parts are easily inserted and centered relative to each other.

In this embodiment, the mechanical coupling between the cartridge and the respective transmission means of the dispenser 10 is thus made in a mainly radial direction relative to the axis of rotation of the cartridge, rather than in a mainly axial direction such as with the preceding versions (practically, however, in this example, the coupling is of a substantially mixed type, i.e. partially radial and partially axial).

A different embodiment of the invention is illustrated in FIG. 18-21, in accordance with which the cartridge, designated herein with 40′, has receptacles that are opened only in the radial direction, rather than in the direction of the axis of rotation of the cartridge. In this embodiment, the body of cartridge 40′ has an upper wall and a lower wall, designated as 43′ and substantially parallel to each other, a central tubular portion 41′ carrying the teeth 47 and a series of partition walls 44′ radially extending from said central portion, to the outer circumference of the walls 43′, such as to define the receptacles containing the washing agent, one of which is designated as 45′.

In the case illustrated herein, accordingly, the doses 46 have substantially the shape of a cylinder sector, having a plan profile that is substantially similar to that of opening 33a′ of the body 30. Also in this embodiment the doses 46 can be configured as tablets having a shape matching that of the receptacles 45′, inserted in the latter with a slight interference and in a substantially radial or perpendicular direction relative to the cartridge axis of rotation. Alternatively, a powdered detergent can be compacted, or sintered, or a liquid, settable detergent can be injected, or moulded during manufacture of the cartridge 40′ within the various receptacles 45′. Thus insertion may be by means of radial compression or injection, particularly inwardly from the outer periphery, i.e. towards the central tubular portion 41′.

In this case, as may be seen in FIG. 20-21, the delivery opening of the dispenser 10, designated as 33a′ is provided on the circumferential wall 31a of the moving body part 30, configured herein as a sliding drawer.

A further possible embodiment of the invention is illustrated in FIG. 22-23, in accordance with which the cartridge, designated herein with 40″, has a generally tapered or inclined outer shape.

The cartridge 40″ comprises, in this case, a central portion 41″ substantially of the type illustrated in FIG. 16-17, and a peripheral wall 42″ having the shape of a truncated cone, i.e. inclined relative to the axis of rotation or of movement. Between the central portion and the peripheral wall there extend a plurality of radial partition walls, one of which is designated as 44″: in the example given herein, accordingly, the receptacles—one of which being designated as 45″—are axially open on both faces of cartridge 40″. The cartridge body may have, in any case, also a bottom wall, as explained above. The doses of the agent 46 contained within the cartridge 40″ have a shape corresponding to that of said receptacles 45″.

The cartridge 40″ may advantageously be used when the dispenser 10 is mounted for use in an upright orientation, such as on the double door 4a (such as in FIG. 8) or one of the side walls of the dishwasher chamber, in order to facilitate the drainage and/or outflow of the washing agent dose contained within the receptacle 45″ at the delivery opening 33a, as well as the washing of the receptacle: as the inner surface of the peripheral wall 42″ of cartridge 40″ is inclined, both the outflow of washing agent and removing liquid of the latter are facilitated, thus mitigating the risk of stagnation.

In the embodiments illustrated above, the cartridge according to the invention is intended to be angularly displaced, in order to bring each receptacle to the delivery opening of the dispenser: it will be appreciated, however, that the cartridge can be configured to move in different manners, such as in a rectilinear manner, in order to be used on a dispenser arranged for the purpose. A specific embodiment is illustrated in FIG. 24-26.

The dispenser 10 illustrated in these figures comprises a stationary body 220 which has a mainly prismatic or parallelepiped shape, defining a housing 231 longitudinally extended and open in the front thereof. A moving part 230, configured as a folding lid, provided with delivery opening 233 is hinged on top of the body 220.

A linearly sliding cartridge, generally designated as 240, can be inserted in the upper part of the housing 231, having a general parallelepiped shape herein, and being divided into a plurality of receptacles 245 located side by side, each being intended to contain a respective dose of washing agent. Similarly to the above embodiments, the cartridge body 240 preferably has a generally rigid structure, which is made of, for example, moulded plastics and can be freely removed from the dispenser.

In FIG. 26, a rack arrangement 247 can be seen, which is provided on the lower wall of cartridge 240, and suitable to co-operate with respective actuating and/or transmission means of the dispenser 10.

In a particularly advantageous embodiment of the invention, the lower wall of the cartridge 240 integrates, i.e. it is shaped to also provide an excitation element, generally designated as A, which is intended to induce signals in an encoder sensor 270 of the dispenser 10, i.e. a sensor suitable to detect the position of the cartridge 240 within the housing 231.

In the case illustrated herein, the sensor 270 is an optical sensor, comprising an emitter and a receiver of electromagnetic radiation, and the excitation element A has a generally linear form and is encoded by means of an alternating series of relief portions or projections and cavities, designated as A1 and A2, respectively. The sensor 270 is preferably mounted to the body of the dispenser in a position aligned to the area of the cartridge 240 in which said projections and cavities are formed.

When a cavity A2 is found in front of sensor 270, the electromagnetic radiation from the relative emitter will not be reflected to the receiver; in contrast, when a projection A1 is found in front of sensor 70, the receiver of the latter will be excited: on the basis of this operating principle, the movement of the cartridge can be detected.

The excitation element A can be encoded, by means of the cavities A2, as a function of the desired type of information to be detected and/or sent to the user, for example: cartridge used-up, cartridge currently contains “n” doses, cartridge position, receptacle/dose positioned at the delivery opening, incorrect cartridge position, etc.

Generally speaking, accordingly, the excitation element consisting of the projections A1 and cavities A2, in the predefined position relative to the receptacles 245, provides, due to the relative movement of cartridge and dispenser body, at least one piece of information representative of the number of doses of washing agent remaining (or used) and/or a condition and/or position of the cartridge within the housing 231.

It should be noted that the functions of the cavities A2 may be accomplished by projections A1, and that cavities and projections may be in a number and/or position other than what is illustrated in the figures. The excitation element A may also be encoded by means of an alternation of opaque and transparent/reflecting sectors, rather than by means of cavities and/or projections of an opaque body.

The encoder detecting system of dispenser 10 can be of a type other than that illustrated herein, such as a magnetic or inductive encoder instead of optical encoder, i.e. arranged to detect a magnetic field or a magnetic field variation. In this embodiment, the projections A1 or cavities A2 can be replaced with permanently magnetized inserts. Suitably both the projections A1 and the cavities A2 may be replaced with permanently magnetized inserts, respectively with North and South (or South and North) polarities, and the encoder sensor 270 will be a detector of magnetic field. Said inserts may also be configured as inserts made of metal or unmagnetized ferromagnetic material; or may be in the form of iron or steel teeth, either moulded together with the cartridge body or inserted therein.

In other words, accordingly, in these variant embodiments, the excitation element does not directly generate a signal, rather, it perturbs or induces a signal in the encoder sensor 270.

The excitation element A, i.e. the part of cartridge body inducing signals to control the latter, can be generally made of plastic ferrite, i.e. a thermoplastic material over-moulded onto the cartridge in the desired shape and then magnetized in the preferred manner and direction (number and position of sectors, direction and polarity of the magnetic field of sectors, etc.), even in a different shape from that depicted herein. Obviously, as stated above, said sectors may be replaced with magnetized or ferromagnetic inserts of the body of cartridge 240. It should be also understood that the excitation element A may be associated with another longitudinal wall of cartridge 240.

In the example illustrated in FIG. 25, the first receptacle 245—on the right in the figure—after the cartridge 240 has been inserted within the dispenser 10, is in a position corresponding to that of opening 233. It is understood that, in the initial position, the cartridge 240 may also be in a backward position relative to the case illustrated herein, i.e. such that the first receptacle 245 on the right comes to face the opening 233 only after a first actuation.

In accordance with further inventive aspects, the support described above can be used in combination with a so-called blister package, i.e. having a poorly rigid envelope. This envelope can be made from, for example, plastic sheets, i.e. a plastic and an aluminium sheet coupled to each other: a first, thicker sheet is shaped to define a series of cells or alveoli, each suitable to contain a respective dose of detergent, the second, thinner sheet being instead essentially configured as a removable film. In such a package, accordingly, the film sheet is removed, before the blister is loaded within the dispenser 10 and/or cartridge 240; the sheet defining the alveoli containing the detergent is positioned within cartridge 240, which thus merely acts as a support for the blister, and both are inserted within the dispenser 10. In another embodiment the removable film is of a water-soluble plastics material, for example polyvinyl alcohol, and is removed by progressive dissolution, cell by cell, in use. In a different embodiment, the blister can comprise the shaped sheet alone, which defines the alveoli, and may be contained within a respective protective sealed plastic envelope, without thus being required to provide a removable film sheet.

A blister according to a possible embodiment of the invention can be seen in FIG. 24, wherein it is designated as 300, only as to the plastic part defining the alveoli, designated as 345, which are shown empty of detergent. It may be observed that the blister 300 is shaped such that the alveoli 345 can be at least partially received in respective receptacles 245 of cartridge 240.

Also in the other embodiments, the cartridge previously designated as 40 can simply act as a support for a blister package, or can be replaced with a specific support for this package.

In FIGS. 27 and 28, for example, a blister 300 is shown for use in combination with the cartridge designated above as 40. Also in these FIGS. 27 and 28, the blister 300 is illustrated only as to the shaped sheet in which the alveoli 345 are defined, which are intended to contain the doses of detergents, which are configured substantially as cylindrical-sector-shaped tablets, herein designated as 246. It can be seen that said shaped sheet has an essentially complementary or “negative” shape relative to that of cartridges 40, in order to be capable of being inserted therein. From FIG. 28, it should be particularly noted how the shaped sheet of blister 300 defines a series of radial cavities 345a, between an alveolus and the next one, which are suitable to be engaged on the radial partition walls 44 of the corresponding cartridge 40. In the case illustrated herein, the alveoli 345 are open at the upper face of blister 300, with reference to the figure, but it is understood that the blister may be also conceived to have the alveoli open on the lower face thereof, or yet on both faces as desired (in which case, the blister, when not packaged in a sealed envelope, will be provided with two film sheets that can be selectively removed).

Obviously, on the basis of the same concept as discussed above, a blister having a shape substantially complementary to that of cartridge/support 40″ shown in FIGS. 22 and 23 can also be provided.

On the other hand, in FIG. 29 a blister 300 is illustrated for use in combination with the cartridge 40′ in FIG. 21. In the example, the blister 300, as shown in extended form, has an essentially linear elongate shape, and the shaped sheet defines a series of cylindrical-sector-shaped alveoli 345, for respective tablets 246; in this example, the sheet defining the blister body comprises a series of hollow portions 345′, in the shape of cylindrical sectors, which are connected to each other along at least one side of the respective open face (i.e. the front face), which can advantageously have an arcuate profile.

In this embodiment, due to the flexibility of said plastic sheet defining the alveoli 345, a substantially ring-shaped configuration can be then given to the blister 300, when the blister is mounted by the user, by inserting the various alveoli 345 within the receptacles 45′ of cartridge 40′.

In FIG. 30, a support 240′ is illustrated, which can be used, for example, as an alternative to cartridge 40′ in FIG. 21. In this case, the body of support 240′, which is substantially rigid and made for example in moulded plastic material, essentially has a base wall 243, a tubular hub part 241 being formed in the central region thereof, which part is provided with, in the lower part thereof, suitable means for coupling to the motion transmission system of dispenser 10, such as for example a toothed ring of the type designated above with 47. Radial partition walls 244 are further developed from the tubular side, which define seats 245′. The moving support 240′ is intended to receive a blister 300 on the top thereof, which is provided essentially in accordance with what has been described above with reference to FIGS. 27 and 28 but with the difference that, in this case, the alveoli 345 are open at the circumferential face of blister. In this embodiment, the radial cavities 345a of blister 300, defined between an alveolus and the next one are suitable to be engaged on the radial partition walls 244 of the moving support 240′. It should be noted that the provision of the base wall 243, though preferred in order to give a certain amount of rigidity to the structure of the moving support 240′, must be considered as optional. It should be also noted that said moving support 240′ can also be used as an alternative to the loaders 40 of the other embodiments, in combination with the blister 300 in FIGS. 27 and 28.

Finally, in FIG. 31 there is also illustrated a further possible embodiment of a blister 300, the alveoli 345 thereof being open at the upper face and at the circumferential face of the blister. Such a blister 300 can thus be either used with the dispensers in FIG. 1-21, with the respective supports/cartridges 40, 40′, or with the moving support 240′.

In other implementations of the invention, a dispenser 10 with encoder sensor of the types mentioned above (optical, magnetic, inductive) can be also provided in combination with angularly angular moving supports.

In FIG. 32, for example, a cartridge/support 40 is illustrated with an excitation ring or crown, designated as A′, being formed on the circumferential wall 42 thereof. The excitation ring or crown A2 is formed with cavities A2 opening both in radial and axial manner (i.e. relieves A1 projecting both in radial and axial directions). Said cavities, and/or adjoining projections or relief portions A1, can be advantageously coated with at least one material suitable for optical detection, for example an opaque and/or a reflecting material (such as a varnish, or adhesive tape, or an insert being planted, moulded, welded or glued to the cartridge/support). The cavities A2 and/or projections or relief portions A1 are preferably obtained during a manufacturing step of the cartridge, such as a step of moulding a thermoplastic material.

In the non-limiting example, the case is depicted in which a notch A2 is provided at each receptacle 45, such that an encoder sensor 270 of the dispenser 10 can count the number of receptacles; preferably, a distinguishable notch, for example a plurality of notches, is formed in a predefined position of the cartridge/support, such that the encoder system can also determine the position thereof: for this purpose, two notches A2 can be provided at one receptacle 45, in order to allow the system to detect an initial and/or final position.

The optical sensor 270 of the dispenser 10 faces the region of the cartridge/support 40 in which the cavities A2 and/or projecting portions A1 used for detection are provided, which form the excitation crown A′.

FIG. 33 illustrates an embodiment similar to that in FIG. 32, but in which the support 40 is provided, rather than with a series of teeth 47, with an individual axial projection 47′ being formed along the inner surface of the central tubular portion 41; this projection 47′ is in the form of an axial rib and is intended for insertion within a respective seat being formed in a transmission member of the dispenser, not shown, which is intended for insertion within said tubular portion 41.

On the other hand, FIG. 34 illustrates the case of a cartridge or support 40 having an excitation ring A″ coded by means of sectors or discrete areas N and S, which may be permanently magnetized (N—North; S—South), to co-operate with a magnetic field sensor 270′ of the dispenser.

In the exemplary case, the ring A″ is magnetized in alternate sectors, i.e. with alternated North and South polarities. The ring A″, formed as part of the body of the cartridge 40, can be made of plastic ferrite, as mentioned above. Obviously, also in this case, the sectors S and N may be replaced with magnetized or ferromagnetic inserts of cartridge 40.

Obviously, the moving supports 240′ for the blisters 300, which also may have a configuration other than that illustrated above, may certainly also contain suitable excitation elements of the type described with reference to FIG. 32-34, in order to be used in combination with an encoder detecting system.

Similarly to what has been described above with reference to the example in FIG. 32, the sectors N and S can be also made of a suitable material, either magnetic or otherwise suitable to alter or induce a magnetic field, such as in form of elements moulded, welded, glued or otherwise applied to the cartridge.

The sectors N and S are preferably obtained during a manufacturing step of the cartridge, such as a step of moulding plastic ferrite over the thermoplastic material making up the cartridge body.

In the non-limiting example in FIG. 34, a pair of sectors N and S is shown at each receptacle 45 of the cartridge 40, such that the encoder system can count the number of receptacles, similarly to what has been explained above with reference to the cavities A2. In this case, also, adjacent pairs of sectors N or S, or preferably at least two pairs of sectors N and S, can be provided (not shown), at a same receptacle of the cartridge, in order to be capable of determining an initial and/or final position.

In accordance with a further embodiment, such as illustrated in FIG. 35, a dispenser 10 comprises a body 220 mainly having a prism or parallelepiped shape, which defines a housing or positioning region 231 that is elongate and open at the front thereof. In accordance with an embodiment, a moving part of body 230 is hinged to the top of the body 220, the moving part being configured as a folding lid.

Advantageously, said dispenser 10 comprises a delivery opening 233, for example arranged on a side thereof, which is suitable for supplying means for dissolving at least one portion of a substance (e.g. dishwashing detergent).

Said dispenser further comprises a further opening 501 suitable as an inlet for the substance dissolving means.

Advantageously, said inlet opening 501 is provided in a region of the dispenser and support or cartridge that, upon operation, will allow the collection (arrows 509 in the figure) and inflow of the dissolving means (such as in an upper portion of the dispenser). With further advantage, said inlet opening 501 is provided on the bottom of a collection channel 500 for the dissolving means, which is suitable to increase the surface exposed to the collection of said dissolving means and to convey the latter to said inlet opening 501.

In accordance with an embodiment, a linear-sliding cartridge, or support, generally designated as 240, can be inserted in the upper part of the housing 231, which cartridge has a general parallelepiped shape herein, and is divided into a plurality of receptacles 245 disposed side by side, each being intended to contain a respective dose of agent, such as washing agent. Similarly to the above embodiments, the cartridge body 240 preferably has a generally rigid structure, which is made of, for example, moulded plastics and can be freely removed from the dispenser.

This cartridge comprises a rack assembly, which is provided on the lower wall of cartridge 240 suitable to co-operate with respective actuating and/or transmission means of the dispenser 10.

In a particularly advantageous embodiment of the invention, the lower wall of the cartridge 240 integrates, i.e. it is shaped to also provide an excitation element, generally designated as A, which is intended to induce signals in a sensor, for example an encoder 270 of the dispenser 10, i.e. a sensor suitable to detect the position of the cartridge 240 within the housing 231.

In an embodiment, said cartridge comprises a plurality of inlet openings 502, one for each receptacle 245 such as to allow the dissolving means to enter, when the cartridge faces the inlet opening 501 of the dispenser the inlet of the dissolving means (arrow 510 in the figure).

Advantageously, said cartridge further comprises cartridge outlet openings 503, one for each receptacle 245, and aligned with respective inlet openings 502, such as to allow the dissolving means (arrow 512 in the figure) to exit together with the dissolved substance, when the cartridge is facing the delivery opening 233 of the dispenser. Openings 502 and 503 are aligned with each other.

In accordance with further inventive aspects, the support described above can be used in combination with a so-called blister package, or blister, i.e. having a somewhat non-rigid envelope. This envelope can be made from, for example, plastic sheets, i.e. a plastic and an aluminium sheet coupled to each other: a first, thicker sheet is shaped to define a series of cells or alveoli, each suitable to contain one respective dose of detergent 504, the second, thinner sheet being instead essentially configured as a removable film. In such a package, accordingly, the film sheet is removed before the blister is loaded to the dispenser 10 and/or cartridge 240; the sheet defining the alveoli containing the detergent is positioned within the cartridge 240, which thus simply acts as a support for the blister, and both are inserted within the dispenser 10. Alternatively the removable film may be removed by being soluble in the means for dissolving the substance.

In accordance with an embodiment, this substance-containing sheet also comprises a plurality of aligned inlet and outlet openings for said dissolving means, which are aligned with said openings 502 and 503 of support 204, when the blister 300 is located in the support 204.

Advantageously, the dose of substance 504 contained within each cell comprises a cavity or duct 505 made of (that is, formed in) the same substance and suitable to allow a flow (arrow 511 in the figure) of the dissolving means between said inlet opening and said outlet opening.

In a different embodiment, the blister can comprise the shaped sheet alone, which defines the alveoli, and be contained in a relative protective sealed plastic envelope, thus without requiring a removable film sheet.

A blister according to a possible embodiment of the invention can be seen in FIG. 35, where it is designated as 300, where the plastic part defining the alveoli containing the substance to be delivered, such as detergent, is designated as 345, which are shown as being filled with substance 504. It may be inferred that the blister 300 is shaped such that the alveoli 345 can be at least partially received in respective receptacles 245 of cartridge 240.

The manufacturing details and the embodiments may be certainly widely changed with respect to what has been described and illustrated herein, without however departing from the scope of the present invention as defined in the claims below.

In one possible variation, in order to facilitate the manual positioning of the cartridge in a preset angular position within the respective housing, a reference notch or groove is provided in the cartridge peripheral wall 42. In this case, the dispenser body will be provided with a mechanism comprising a cursor biased by a spring against said peripheral wall, the tip of this cursor being capable of being received within the notch or groove, when the cartridge is in said preset angular position. Said notch or groove may be replaced with a projection or relief portion, or have a different shape suitable to co-operate with a complementary-shaped part or mechanism. The actuating force produced by the dispenser moving means will certainly be such as to allow the notch or groove, or projection or relief portion, to be disengaged from the cursor.

In other solutions, the reference means (A; A′; A″; 49, 49a, 49b) can be integrated within the support body or cartridge (40; 40′; 40″; 240; 240′) by means of insertion or fixing, such as coupling, gluing, welding, screwing, over-moulding, carried out during or subsequent to the manufacture of the body.

In accordance with a further embodiment, a blister is directly accommodated within a positioning region of the dispenser (FIG. 36). The positioning region may be provided with respective receptacles (not shown) to receive the alveoli of the blister.

Preferably, though not necessarily, this dispenser is entirely similar to what has been described above with reference to FIG. 24, or preferably FIG. 35. In this embodiment illustrated in FIG. 36, the same numerals of FIG. 35 are used for designating similar components and parts.

Advantageously, said blister comprises reference means in a predefined position that are configured to provide, during a relative movement between said support and at least one part of the device, a piece of information representative of at least one of:
the number of doses of substance provided within, or already supplied by, or remaining within, the support,
a condition and/or position of the support relative to a dispenser body portion.

Further advantageously, said blister comprises transmission means configured to co-operate in a uncouplable or releasable manner with the dispenser actuating system.

The characteristics illustrated and described with reference to a specific embodiment of cartridge and/or support can obviously be used also with the other versions illustrated or described herein, for example relative to the shape of the coupling means with respect to the dispenser actuating system, relative to the excitation means type, or relative to the visual signalling system. Obviously, the signalling system described with reference to FIGS. 11 and 12 can be also adapted to the case of cartridge or support with linear motion (FIGS. 24 and 25), in which the visual indicator will be axially developed on one of the longer walls of the prism-shaped body, in order to be visible through a window or the like, which is formed in the dispenser body.

Also in the case of a cartridge/support with linear motion—of the type as illustrated in FIG. 26—at least one of the side walls of the relative body may be inclined, in order to facilitate the drainage and/or outflow of the washing agent doses from the respective receptacles, similarly to what has been described with reference to the support or cartridge in FIGS. 22 and 23.

In accordance with one embodiment, sealing elements partially provide excitation elements, such as a rubber or elastomer composition over-moulded to the support, providing both sealing lips and projections and/or notches as the excitation elements for the encoder.

In accordance with a further embodiment, the cartridge or support or blister advantageously comprises or is associated with sealing elements or gaskets, of a type suitable to co-operate with at least one part of the dispenser. Said sealing elements are advantageously made of an elastic material or rubber or from an elastomer.

Advantageously, said sealing elements are moulded or directly over-moulded with or to the cartridge or support or blister, or they are separately manufactured and then mounted to the cartridge or support or blister, preferably held in position due to the elasticity of the material or by means of suitable fixing or coupling means.

In accordance with one embodiment, the sealing elements for example are suitable to be associated with at least one part of the support or blister, such as a part of said radial partition walls 44,244 and/or of the tubular portion 41,241, and/or peripheral wall 42 and/or base wall 43, 243. The sealing elements are either separated from or joined to each other to form an individual sealing element. The cartridge or support or blister is advantageously configured such as to allow fixing said sealing element, preferably in a predefined position, such as by being provided with holes or seats or projections or other relief parts.

Said sealing element, for example, also provides part of said reference or excitation elements, such as for example a gasket that is shaped such as to provide also seats A2 and projections A1 that can be detected by means of a respective optical transducer or sensor or encoder.

A description of an exemplary embodiment of a support or cartridge is provided below.

In accordance with an embodiment, a general embodiment of a manufacturing method contemplates:
providing at least one mould having a suitable shape to make said support and at least one of said excitation or reference and/or sealing means;
injecting at least one material suitable to provide said support and at least one of said excitation or reference and/or sealing means.

Further advantageously, in accordance with a particular embodiment of the method, there are provided at least the steps of:
providing a first mould with a shape suitable to make both the support and at least one of said excitation or reference means as one piece;
injecting a first material suitable to make both said support and at least one of said excitation or reference means as one piece.

In accordance with a further manufacturing method, there are provided at least the steps of:
providing a first mould, consisting of at least one first part and a second part of mould with a shape suitable to make the support;
injecting a first material in said first mould to make said support;
removing at least one of said first and second parts of the first mould;
providing at least one second part of mould with a shape suitable to make at least part of said excitation or reference and/or sealing means;
injecting a second material suitable to make at least part of said excitation or reference and/or sealing means of said support.

In accordance with a manufacturing method, there are provided at least the steps of:
providing a first mould with a shape suitable to make the support;
injecting a first material in said first mould to make said support;
removing said support from said first mould;
providing a second mould with a shape suitable to make at least part of said excitation or reference and/or sealing means;
inserting said support within said second mould;
injecting a second material suitable to make at least part of said excitation or reference and/or sealing means of said support.

Advantageously, there are provided at least the steps of:
providing a first mould with a shape suitable to make the support and being provided with at least one seat for at least one insert;
positioning at least one insert within said at least one seat of the first mould suitable to make said excitation and or reference means;
injecting a material within said first mould which is suitable to make said support.

Preferably, at least one of the following steps is provided:
providing at least one magnetic or magnetized insert within at least one seat of the mould;
providing at least one metal or ferromagnetic insert within at least one seat of the mould.

Further advantageously, at least one of the following steps is provided:
injecting a thermoplastic material;
optionally injecting an elastomeric material;
injecting a material, either molten or fluidized following a heating operation;
injecting a resin or fluid material suitable for hardening after injection (for example by cooling);
inject a material suitable for hardening within the mould;
injecting a plastoferrite or ferromagnetic material or a material suitable to be magnetized.

Still further advantageously, at least one of the following further steps is provided:
magnetizing said at least one insert;
   magnetizing said excitation or reference means;
   magnetizing said support

In accordance with a manufacturing embodiment, there are provided at least the steps of:
providing at least one mould with a shape suitable to make said support;
injecting at least one material suitable to make said support;
fixing (e.g. gluing or welding) detection or excitation and/or sealing means or elements to the support.

Advantageously, at least one of the following steps is provided:
fixing (e.g. gluing or welding) at least one optical element;
fixing (e.g. gluing or welding) at least one magnetic element;
fixing (e.g. gluing or welding) at least one reflecting or coloured element with graphic symbols.

In accordance with an embodiment, in FIGS. 37a, 37b and 37c, a general mould is designated as 600 comprising a first mould part 601 and a second mould part 602, which are internally configured such as to provide a hollow shape matching the shape of the support 40 desired to be made. In the second mould part 602, at least one opening 605 is provided, which is suitable to allow injection of a material into the mould; said material being suitable to fill said hollow shape in order to at least partially make said support 40. Said material is preferably a thermoplastic material or a resin. Said material may be any molten material which sets on cooling or any material suitable to be injected, and at least partially cure within the mould.

In a first example of manufacture or moulding of support 40, said two parts 601, 602 of the mould are joined to each other to form said hollow shape; then, via the opening 605, material is injected into the mould to fill said hollow shape. After a short time, i.e. after cooling or curing of the injected material, the mould is opened, i.e. said two mould parts 601 and 602 are moved away from each other, such as to be capable of removing the support or cartridge 40 from the mould.

Preferably, said mould and said support have such a shape as to allow moulding with mould parts which are suitable to be opened only one-way, i.e. such that complicated shapes are not obtained using this type of mould. To the end, the support is preferably defined such that it does not have any shape of the so-called “undercut” type, i.e. such as to prevent the piece from being removed from the mould with a one-way opening movement of the mould.

The support described with reference to FIG. 37a,37b,37c may be not provided with detection or excitation means or be a monolithic piece that integrates said detection or excitation means, which are obtained during the same support-moulding step.

To the purpose, shapes are advantageously provided within the mould, such as seats and relieves, which are suitable to provide a complementary or negative shape of the detection or excitation elements of the support, not visible in FIG. 37a, 37b, 37c. Alternatively, the entire support 40 may be moulded from a material suitable to make said detection or excitation elements, such as a magnetizable thermoplastic material, or for example, plastic ferrite.

In accordance with a further embodiment, FIGS. 38a, 38b and 38c there is shown a second mould 600″, comprising a first mould part 601″ and a second mould part 602″, which are internally configured such as to provide a hollow shape comprising at least one first part matching the shape of the support 40 desired to be made, i.e. suitable to house said support 40, and comprising at least one second hollow part of a shape matching the shape of the reference or excitation elements desired to be made. Said second hollow shape is partially designated with the numerals 603″ and 604″, positioned in communication with an inlet opening 605″ for a second moulding or over-moulding material, such as a plastic ferrite.

After the support has been, for example, manufactured according to what has been described above with reference to FIGS. 37a, 37b and 37c, after the support 40 has been positioned within the second mould part 602″, the latter is closed by approaching the first part 601 thereto; said second material is then injected into the opening 605″, such that it is distributed throughout the second hollow part, for example having an annular shape, in contact with said support 40. After a time, i.e. after at least partial solidification of the second material, the mould is opened in order to remove the support 40 integral with the detection or excitation element A, over-moulded onto the support 40.

Alternatively, at least one part of the mould may also be suitable for insertion of inserts into the mould. To this purpose, said second hollow shape may be at least partially shaped to match at least one of said inserts, such as to be capable of holding the latter in a predefined position during the moulding or over-moulding operation, in order to obtain a support 40 that is co-moulded with inserts suitable as detection or excitation means, such as magnetic or ferromagnetic or metallic inserts.

In the case of a moulded or over-moulded support made of magnetic material, such as a plastic ferrite, or in the case of a moulding with magnetizable inserts, a magnetization step may be advantageously provided subsequent to said moulding or over-moulding operation(s).

Further embodiments of the support or cartridge of the invention will be detailed herein below.

The dispenser according to the variant embodiment in FIG. 35 or 36 may employ only the refill or cartridge or support 240, without the blister 300, in which case the washing agent, preferably in integrated compact units or monolithic doses will be directly inserted and stored within the receptacle 245, preferably with a slight interference. On the other hand, the blister can be made to directly operate in combination with a respective dispenser, even in the absence of a support.

In this case, it is the blister body which is the support means for the plurality of substance separate doses, which is configured such as to directly define the means allowing the same to be either coupled with the transmission system of the dispenser and/or to co-operate with the detecting system thereof.

For example, with reference to the embodiments of FIG. 36, the sequence of notches or projections that are formed on the body of blister 300, or the lower part of blister 300, which is already substantially rack-shaped (resulting from the sequence of the receptacles 245 having a substantially trapezoid profile), will be suitable to co-operate with a pinion.

Said sequence of notches or projections of the blister, or the “toothed” shape of the lower part thereof, can be also conveniently used as the excitation element for a detecting system, for example by optical encoder. Alternatively, the blister body can define a special sequence of parts, such as projections and/or cavities, acting as the excitation elements.

Naturally, the blisters of the further above-described embodiments, such as circular-shaped, can be also suitable to directly co-operate with a respective angularly moving dispenser, which is correspondingly configured.

In this variant embodiment, accordingly, the body of these blisters will define the respective coupling means to the dispenser transmission system and/or the excitation means for the detecting system or encoder and/or of the visual signalling system.

The provision of a dispenser with an inlet opening and an outlet opening for the liquid which removes the washing agent can be obviously also used in the other above-described embodiments.

FIG. 39 illustrates, for example, a general movable body 30, for a dispenser according to one or more of the above embodiments, with a refill or blister support that is either pivotable or angularly movable. In this case, the body 30 provides two openings 233a and 233b being formed on two walls that are orthogonal to each other, at precisely the bottom wall 31b and the peripheral wall 31a of the housing for a respective refill or blister support, which is provided with respective openings in its peripheral wall and in its base wall.

The relative position of the openings 233a, 233b is such that both face said respective openings of the receptacle/seat for the refill/support, contained within the housing thereof, the liquid being capable of reaching the washing agent through one of these openings, in order to dissolve and thus carry the latter therewith, through the other opening.

For example, a dispenser provided with a movable body in FIG. 39 can be designed to be mounted onto the double door of a machine. In this case, the opening 233a will be exposed to the washing jets, for the liquid to flow into the dispenser and refill and/or blister, whereas the opening 233b will face downward, for the liquid to flow out from the dispenser together with the related delivery of the washing agent.

In an advantageous embodiment, the position transducer or detecting system or encoder can be of absolute (or “YES-NO”) type.

In accordance with a possible variant embodiment of the support or cartridge that can be associated with the dispenser, an excitation element or ring is provided which can be associated with said support.

In an example of this embodiment, the excitation element or ring of the refill or support comprises two distinct sequences or series of cavities/projections. For example, the first series of cavities/projections is configured so as to provide data encoding, particularly binary data, and hence of the absolute type, which identifies the position of the refill or support relative to the dispenser and/or relative to the dispenser delivery opening; the second series of cavities/projections is configured to generate a synchronization signal that can be used to allow an accurate reading of said data or binary codes that are provided by the first series, which should be otherwise carried out in a timed manner.

In accordance with an embodiment, the first coding series is carried out at an intermediate step of the refill ring or support, whereas the second synchronization series is carried out at, for example, the lower edge of the ring. This configuration of the ring allows an easy moulding of the latter, using a one-way openable mould (i.e. formed, for example, by two half-moulds that are moved together into contact while they are being closed and moved away while they are being opened). Thereby, the mould, particularly for the injection of thermoplastic material, can be relatively simple, without requiring moving parts, such as carriages or movable inserts, which are conversely indispensable in the case where the cavities/relieves are made by undercut working (i.e. in a recessed position within the piece, which makes the piece impossible to be removed from a one-way opening mould); obviously, when required, configuration providing more complicated moulds can be also envisaged.

Two respective sensors of the dispenser face the two series. It should be noted that, alternatively, both series can be formed on the top edge of the ring, in alternating manner or the one on the inner perimeter and the other on the outer perimeter of the ring.

On the other hand, FIG. 40 illustrates the case where an excitation ring A for an absolute encoder is integrated within a support or cartridge 40. The excitation ring A in FIG. 40 has a series B′ of cavities/projections configured to provide data encoding, particularly a binary or Gray code, and thus is part of an absolute encoder, where a given code identifies/distinguishes a given receptacle of the refill 40. Further, it has a series of cavities/projections B″ configured to generate a clock or synchronization signal. Except for the different type of encoding (binary codes or Gray codes), the operating principle is the same for the series A′ and the series B′. It should be noted that the embodiment in FIG. 40, in which both series B′, B″ are formed on the opposite edges of the ring A, without undercut parts, also permits simplified moulding of the part, particularly according to the techniques described above.

Both series B′, B″ in FIG. 40 can be formed on a same edge of the ring A, in an alternating manner or in a different arrangement.

The excitation means or absolute codification means can be formed in excitation rings A that can be removed from the support or cartridge thereof.

An absolute encoding, with optional series of synchronism cavities/projections, can be also alternatively envisaged in the case of a refill—or support or blister which undergoes linear movement.

The elements of data encoding and optional synchronization can be directly obtained in the blisters, for those dispenser versions that do not require any refill or support for the blister.

In the above-described embodiments, the support or cartridge co-operating with a dispenser is described with reference to a position/movement encoder or transducer being substantially of a digital type.

The direct or indirect detection of the position and/or movement of the support means for the substance to be delivered (for example a refill, movable support or blister) can be however carried out also using a substantially analogue position transducer.

To this end a support or refill 240 which is to undergo linear movement is schematically depicted in FIG. 41, and which is provided with respective receptacles 245. The support or refill 240 has, along one of the sides thereof that is parallel to the direction of movement (a longer side herein), an excitation element C′, defining a readable or detectable profile or inclined plane P.

The plane P of the excitation element C, which is supposed to consist of a magnetic material (for example magnetized plastic ferrite) is intended to result more or less approximately—as a function of the linear movement of the support or refill 240—to a respective analogue magnetic sensor, which is mounted in a stationary position to the stationary part of the dispenser and suitable to output a signal proportional to the intensity of the magnetic field being detected, i.e. proportional to the distance of the same from the inclined plane P. The operation of the analogue excitation element C′ is exemplified in FIG. 42, which shows said sensor, designated as 70′, and the excitation element C′ designated as I, II and III, corresponding to three different positions of the refill or support 240, for example initial, intermediate and final positions. The intensity of the magnetic field (schematized as D) detected by the sensor 70′ is proportional to the position of the support or refill 240; accordingly, the position of each receptacle 245 corresponds to a level or predefined value of the intensity of a magnetic field detected by sensor 70′. Alternatively, the excitation element C may be again formed of magnetic material (for example magnetized plastic ferrite) but be intended to result at a constant distance during the movement of the support 240 relative to the analogue magnetic sensor of the dispenser; in this case, the excitation element is advantageously magnetized with different values of magnetic field for the extension or length or perimeter thereof, or it is magnetized in sectors of different magnetic field intensities, in order to induce in the sensor a signal proportional to the intensity of the magnetic field detected, i.e. proportional to the position of the excitation element relative to the position of the sensor within the dispenser.

FIG. 43 schematically illustrates another example of operation of the analogue excitation element C′, wherein the sensor 70″ is of the type having a movable cursor, wherein the signal value proportionally varies according to the movement or travel of the relative cursor. In this case, the excitation element C can be formed as one piece with the body of the support 240, for example of thermoplastic material. In this implementation, the plane P moves the cursor of sensor 70″ according to the more or less forward or backward position of the support 240 (FIG. 41), with consequent variation in the value of the sensor signal in the various positions.

Obviously, an analogue excitation element C′ can also be used with an angularly moving support. FIGS. 44 and 45 schematically illustrate a support 40 equipped with an excitation device C″ that is mainly circular, but has an eccentric or “spiral” outer profile P, which is either associated with or integrated to, for example, the circumferential wall of the support. FIG. 44 illustrates the case of an excitation element C′ for a magnetic transducer, that is conceptually similar to that in FIG. 42, with excitation element C″ being made of magnetic material.

On the other hand, FIG. 45 illustrates the case of an excitation element C′ for a transducer with movable cursor, which is conceptually similar to that in FIG. 43, with the excitation element C″ being made of any material. It should be noted that the development of both elements C′, C″ exemplified herein can be considered as being equivalent to a triangle or prism with inclined plane (a different development or profile P may be further adopted, provided it is suitable to create a proportional variation in the sensor 70′, 70″).

It should be also noted that the analogue excitation elements C′, C″ referred to in the non-limiting examples in FIG. 41-45 can be considered as being equivalent to excitation elements for absolute encoders or transducers, since the position detected is univocal or unambiguous (as stated above, the value detected by the sensor 70′, 70″ is always correspondent to a predefined position).

It is understood that an analogue excitation element can be used for the purpose of directly detecting the position of a blister, instead of a support, which will be consequently equipped with excitation elements of the type designated as C′ and C″, which can be detected by a respective sensor 70′ or 70″ of the dispenser.

Among the advantages of the invention, should be highlighted the simplicity of construction of the support or refill, whose components are mostly obtainable through simple moulding operations of thermoplastic materials. The support has extremely small overall dimensions and is very simple and comfortable to use, for a user.

The fact that, in certain embodiments, the support or refill or blister is intended to selectively co-operate with the dispenser actuating means, by shifting to an inoperative condition of non-coupling with the dispenser, allows the same to be easily removed to be replaced or refilled or periodically cleaned.

The fact that the refill or support or blister is arranged to retain discrete portions of a solid substance within receptacles or alveoli that are isolated from each other, avoids the risk of clogging typical of the prior art solutions.

The fact that the dose of substance is of a “monolithic” type, for example in the form of a tablet or other discrete portion, and preferably integral with the support or refill or blister and removable only by means of a fluid, allows holding the substance in an optimum position for at least a significant part of the delivery cycle from the dispenser, particularly with a precise positioning of the dose of substance relative to the above-said fluid flow.

The fact that, preferably, the refill or blister or support are of a type suitable to remain always entirely within the dispenser body, in normal operation, particularly when of the type where even the part thereof with the receptacles/alveoli remain protected, from which the washing agent has been already removed, avoids both the presence of further bulk in the machine washing, and the risk that the movement of the support may be hindered and stopped by outer bodies, such as a tableware basket or rack or the contents thereof, with a risk even of breaking the tableware due to possible interference.

The support means for the doses (i.e. the refill or support, including blister support, or the blister itself) may of course have a shape other than those described and/or illustrated above, for example with a cylindrical sector shape (i.e. define only an arc of a circumference), or a combination of shapes that are at least partially circular and linear.

Similarly, the excitation element for the encoder system may also have shapes other than those exemplified above. For example, this excitation element may have a semicircular shape, in the case of the embodiment mentioned just above in relation to a refill or support or semi cylindrical blister, or a combination of at least partially circular and linear shapes, or shapes that are at least partially similar or complementary to those of the support means; another possibility is that of integrating or associating the excitation element in an inner or central area of the refill or support, for example in the shape of an annular element of a limited diameter, proximate to the toothed crown 47.

The substance to be delivered can be in an individual block, such as configured as a large tablet, from which doses of the substance are gradually dissolved during the various operating cycles of the equipment. In this case, the support means for the doses to be delivered can be directly represented by the same individual block of substance, which is duly configured to co-operate with the movement transmission system of the dispenser, and optionally configured as a blister; or a specific support can be provided for the block, the block and the support defining means for coupling with each other.

The block is of the type suitable to be moved by the dispenser, according to the various deliveries.

In possible alternative embodiments, the refill or support can be manually refilled by the user with washing agent tablets, which are preferably inserted by interference, optionally provided with a respective envelope as in the above-described blister versions.

The invention has been previously described with reference to a specific use in the dish-washer field, but it is understood that the same can be also applied in the case of dispensers for other domestic “ware washing” equipment, particularly washing agent dispensers for other types of washing machines, such as washing machines and washer-dryer machines.

The term “domestic equipment” is meant to encompass all the devices or equipment that can be present in a house, comprising the installations thereof, and particularly sanitary fittings and/or hydraulic and/or conditioning and/or heating installations.

The support may advantageously also be used in fields other than the domestic one, such as in order to deliver doses of fertilizing substances in irrigation systems, particularly in those systems where a water flow is intended to dissolve and/or remove the substance being delivered.

The term “washing substance” or “washing agents” is further intended to comprise, in addition to detergent and rinse aid substances, also further substances that can be used in the above-mentioned fields of use, such as softeners, perfumes, anti-fading substances, water softeners and scale removers, disinfectants, fertilizers, etc., as well as alle other substances or products that are intended to be delivered in metered doses in a domestic environment.

The elements described with reference to a support or refill, can be entirely or partially applied also to the solutions described with reference to a blister.

The support can be of the type comprising an optical indicator that is capable of having or generating intensity or different types of colour or optical image, wherein this difference in the colour or image is indicative of the angular or linear position of the support means of the substance to be delivered.

A further embodiment can be referred to a refill with a visual indicator, either central or peripheral, such as of the type that can be viewed by the user (see for example FIGS. 20 and 45), of the type detectable by a suitable sensor of the dispenser, such that the intensity and/or type of colour or image of the visual indicator in the various positions corresponds to a respective signal value from an optical sensor of the dispenser.

The sensor device used to the purpose can be advantageously of the type suitable to detect a dimension or height of the optical element.

For example, with reference to a support or refill provided with visual indicator of the same type as that in FIG. 20, a dispenser sensor can discriminate the various heights or arrangements of the coloured elements of the indicator (for example red and green), such as to infer, besides the amount of residual doses within the support or refill, also the angular position thereof.

The visual indicator of the support may also comprise relatively complicated images, for example also containing graphic symbols or numbers associated with the various positions, i.e. corresponding to the various receptacles or alveoli 45, 245.

In a further variant, the doses of the substance to be delivered are configured to constitute a part of the excitation element. In this variant, for example, the doses can be coloured in a variable manner or shaded off within the colour range, the different colours or colour hues being detectable by means of a suitable dispenser colour sensor, of the type mentioned above; similarly, the doses configured as tablets can have different shapes from each other, for example with increasingly different heights, capable of being detected by a suitable tracer of the dispenser, such as a height-position transducer. Differences in colour or shape can be optionally used also to detect different types of refill for a dispenser (such as a white dose for a detergent, a blue dose for a rinse aid, a pink dose for a deodorant agent, and the like).

As mentioned above, certain characteristics and components described with relation to several embodiments and variants can be easily interchanged by those skilled in the art with those of at least part of the other embodiments and variants described herein, i.e. they can be at least partially combined with each other in order to obtain solutions or devices that may be also different from those described and illustrated herein by way of example.

In accordance with an embodiment, a support or refill or cartridge comprises or is associated with memory and/or communication means preferably of the type suitable to allow a detection and/or a control of the behaviour of said support by the dispenser, or suitable to allow a detection also by other devices different from the support and dispenser and equipment to which they are mounted.

Advantageously, said support comprises or is associated with means suitable to store information, that preferably identifies the behaviour and/or the type of support and/or substance/s to be delivered and/or their position within the support; preferably, the information identifying the position of the support is also suitable to identify the type of support and/or substance.

Advantageously, a non-volatile electronic memory, preferably solid state, is suitable to retain information identifying the position of the support within the dispenser and/or the amount of substance within the support. This functionality can be implemented in order to provide the reading by the dispenser of the contents or data of the memory means, or the dispenser could carry out both reading and writing or the update of the data within the memory means (for example by re-writing the value of the position or residual amount of substance). Said embodiment can be advantageously implemented using communication or transmission means, particularly wireless or radio frequency (RF) means, such as for example the known technology of “transponders” or “RFID” or “Tag”, of a read-only type or read/write type, by integrating or associating a suitable electronic circuit or chip or transponder to the support, which has memory and/or communication means, and by providing the dispenser control system with a respective control and/or communication circuit, such as a wireless circuit for the reading and/or writing of transponders or tags. The transponder or the like is integrated in a water-tight manner within the support or within the component associated with the support.

An implementation of this kind is exemplified in FIG. 47, wherein the support 40 is provided with a transponder T or similar circuit or chip and the control system SC of the dispenser or respective user equipment or machine comprises a respective control and/or communication circuit TR for transponder T, defined below as the “reader” for clarity purposes (even though, as will be seen below, it is also capable of carrying out a piece of information writing operation in the memory means of the transponder or chip or circuit T).

In such application, with read/write RF technology, the memory means of the transponder T associated with the novel support or refill 40 contain a datum indicative of the total number of the available doses 46 of substance, which datum is updated (decremented) upon each action on the support and/or dispenser, i.e. each time the support 40 is moved and a dose is consequently delivered. In such application, the control system SC, TR of the dispenser can carry out:

i) the reading of the datum/figure that is stored in the memory means of the transponder T of support 40 (e.g., 8 doses);

ii) the operation or movement of the support 40, i.e. the delivery of one dose of the substance;

iii) the writing of a new datum/figure in the memory means of the transponder T, or update/replacement (for example, 7 doses) of the previously read datum/figure.

The solution described herein allows for the possibility of removing a not yet finished support from the dispenser without losing the information on how much washing agent or other substance has been consumed, or is still available. Let us consider the case of different types of supports that the user may use alternately within the dispenser, for example for the purpose of carrying out different washing regimes, or because of removal of the dispenser in view of a long period of inactivity of a washing machine or in order to replace the latter. Said solution further allows the control system SC of the dispenser to be capable of determining and/or signalling the exact amount of washing agent that is present within the support.

What has been described by way of example essentially corresponds to a “marking” or “tagging” operation on the support by the dispenser, particularly a marking on the support upon each delivery operation by the dispenser (such as a marking on each dose of substance being delivered). As may be seen, the marking on the support can be advantageously of an electronic type, though the support can be suitable for other possible types of marking or tagging that can be obtained by means of any known technology that is suitable to the purpose. Among these, we particularly highlight the possibility of providing a support suitable for a mechanical type of marking, comprising for example a drilling or deformation by the dispenser of at least part of the support of the substance to be delivered, or a component or element being associated or associable with the support. By way of example only, in such variant embodiment, the support comprises a relatively thin plastic part extending throughout the various receptacles for the doses of substance, and the dispenser is provided with a circuit or unit controlled by the control system to produce a drilling or deformation of said plastic part at each receptacle, after the respective content has been delivered; said plastic part thus provides a “mechanical memory”, whereas the above-said drilling or deformation unit or circuit provides a “writing means” of the mechanical memory.

A mechanical marking can be certainly also part of a detection and/or signalling system, such as of the dispenser and/or of the type suitable to inform the user of the residual amount of doses of substance that are contained within the support means.

In FIG. 46, for example, a support 40 is illustrated with an excitation ring or crown, designated as A, being formed in the circumferential wall 42 thereof, which consists of cavities B opening both in radial and axial manner (i.e. projections projecting both in radial and axial directions). Said cavities and/or projections can be advantageously coated with at least one material suitable for optical detection, for example an opaque and/or reflecting material (such as a varnish, or adhesive tape, or an insert being planted, moulded, welded or glued to the cartridge/support). The cavities and/or projections B are preferably obtained during a manufacturing step of the support, such as a step of moulding a thermoplastic material.

In a non-limiting example with reference to FIGS. 24-26, the case is depicted in which a notch A2 is provided at each receptacle 45, such that an encoder sensor 270 of the dispenser 10 can count the number of receptacles; preferably, at least one notch is formed in a preset position of the cartridge/support, such that the encoder system can also determine the position thereof: to the purpose, two notches A2 can be provided at a same receptacle 45, in order to allow the system detecting an initial and/or final position.

The excitation ring A of other embodiments can optionally consist of an independent or removable element. For example, the ring A, or other excitation element replacing the latter, can be directly associated with or mounted to the support or refill 40. The latter possibility is depicted in FIG. 46, in which a ring A is provided, which is intended to be associated with or mounted to the support or refill 40 and coded by means of a series of notches or cavities B along the circumference thereof, which open at the upper face of the ring (FIG. 46 illustrates an excitation ring for an incremental encoder, though the same concept can be obviously applied also to the case of an absolute encoder ring, or the case of an excitation ring of another type).

Of course, the principle of the invention being understood, the embodiments and implementation details may be widely changed as compared with what has been described and illustrated above by way of non-limiting example only, without however departing from the scope of the invention.

There now follows a series of Statements further defining the present invention. The reference numerals are as stated above and as used in the drawings but are given in these statements only for the purpose of illustration and assistance, not limitation A1. A support for at least one dose of deliverable substance, particularly a washing agent, which is arranged to be operatively coupled to a dispenser, the dispenser (10) being of the type comprising an actuating system (66, 67; 250) and a dispenser body (20, 30; 220, 230), having a positioning region (31; 231) for the support (40; 40′; 40″; 240; 240′) and a delivery opening (33a; 33a′; 233),

wherein the support (40; 40′; 40″; 240; 240′) is intended to be either coupled to or inserted within the positioning region (31; 231) of the dispenser (10), such that a relative movement between the support (40; 40′; 40″; 240; 240′) and at least one part (30) of the dispenser body (20, 30; 220, 230) that is caused by the actuating system (66, 67; 250) allows selectively delivering the at least one dose (46; 246),

characterized in that the support (40; 40′; 40″; 240; 240′) comprises reference or excitation means (A; A′; A″; 49, 49a, 49b), in a predefined position relative to the at least one dose (46; 246) and configured to obtain or provide or generate, following said relative movement between the support (40; 40′; 40″; 240; 240′) and at least one part (30) of the dispenser body (20, 30); (220, 230), a piece of information or a figure.

A2. The support of A1 (i.e. statement A1 just given above), wherein said information or figure is preferably representative of at least one of:
an amount of substance dose (46; 246) provided within the support (40; 40′; 40″; 240; 240′),
a condition and/or a position and/or a movement of the support (40; 40′; 40″; 240; 240′) within the positioning region (31; 231).

A3. The support of A1 or A2, wherein said at least one dose is a plurality of doses of deliverable substances.

A4. The support of any of A1-A3, wherein said support is suitable for a long-life dispenser.

A5. The support of any of A1-A4, wherein said support is suitable to be controlled by means of control means that are comprised within said actuation system (66, 67; 250) of the dispenser.

A6. The support of any of A1-A5, wherein said support (40; 40′; 40″; 240; 240′) comprises excitation or memory or communication means that are suitable to be detected.

A7. The support of any of A1-A6, wherein the support (40; 40′; 40″; 240; 240′) defines a plurality of seats (45; 45′; 45″; 245; 245′), each being configured to at least partially accommodate one dose (46; 246), the number of doses in the plurality being sufficient to carry out several deliveries.

A8. The support of any of A1 to A7, wherein said reference means (A; A′; A″; 49, 49a, 49b) are integrated in said support (40; 40′; 40″; 240; 240′).

A9. The support of any of A1-A8, wherein said reference means (A; A′; A″; 49, 49a, 49b) are as one piece with or applied to said support (40; 40′; 40″; 240; 240′).

A10. The support of any of A1-A9, wherein said support is a blister.

A11. The support of any of A1-A10, wherein said support accommodates and supports a blister.

Al2. The support of any of A1-A11, wherein said at least one dose of deliverable substance is, at least at the beginning of the delivery, firmly fastened to said support such that dissolving means can flow to said support and at least partially dissolve said dose and flow out from said opening or a second delivery opening (33a; 33a′; 233) together with the part of dissolved dose.

A13. The support of A12, wherein said dissolving means flow to said support from a second opening separated from said delivery opening (33a; 33a′; 233), such that said dissolving means at least partially flow through said at least one dose.

A14. The support of any of A1-A13, wherein said at least one dose comprises two or more deliverable substances that are different from each other.

A15. The support of any of A1-A14, wherein transmission means (47; 47′; 47a, 47b; 247) are comprises, which are configured to co-operate in an uncouplable manner with the actuating system (66, 67; 250) of the dispenser (10).

A16. The support of any of A1-A15, wherein the reference means (A; A′; A″; 49, 49a, 49b) comprise excitation means (A; A′; A″) that are provided on the support (40; 40′; 40″; 240; 240′) and configured to co-operate or interact with a detecting system (270; 270′) of the dispenser (10) in order to generate said information or figure.

A17. The support of any of A1-A16, wherein the reference or excitation means (A; A′; A″; 49, 49a, 49b) comprise a visual indicator (49, 49a, 49b) being provided on or within the support (40; 40′; 40″) and configured to visually display or generate said information or figure at a predefined position (38; 38″) of the dispenser body (20, 30).

A18. The support of any of A1-A17, wherein the reference or excitation means (A; A′; A″; 49, 49a, 49b) are configured to obtain or provide or generate a piece of information or value representative of at least one of:
a residual amount of substance doses (46; 246) provided within the support (40; 40′; 40″; 240; 240′),
a condition of presence/absence of the support (40; 40′; 40″; 240; 240′) in the positioning region (31; 231),
an operative position, among a plurality of possible operative positions, of the support (40; 40′; 40″; 240; 240′) within the positioning region (31; 231).

A19. The support of any of A1-A18, wherein the reference or excitation means (A; A′; A″; 49, 49a, 49b) are configured to simultaneously obtain or provide or generate a piece of information or figure representative of:
the residual amount of substance dose (46; 246) provided within the support (40; 40′; 40″; 240; 240′),
the operative position, among a plurality of possible operative positions, of the support (40; 40′; 40″; 240; 240′) within the positioning region (31; 231).

A20. The support of A19, wherein said reference or excitation means (A; A′; A″; 49, 49a, 49b) are two separated reference or excitation means, of which first reference or excitation means are configured to obtain or provide or generate a piece of information or value representative of the residual amount of substance dose (46; 246) provided within the support (40; 40′; 40″; 240; 240′) and second reference or excitation means are configured to obtain or provide or generate a piece of information or figure representative of the operative position, among a plurality of possible operative positions, of the support (40; 40′; 40″; 240; 240′) within the positioning region (31; 231).

A21. The support of any of A1-A20, wherein the reference or excitation means (A; A′; A″) comprises a series or sequence of reference or excitation elements (A1, A2; N, S).

A22. The support of A21, wherein the reference or excitation elements (A1, A2; N, S) comprise at least one of
a series of relieves and/or cavities of a support body,
a series of transparent sectors and/or opaque sectors and/or reflecting sectors of a support body,
a series of magnetized inserts integrated in a support body,
a series of inserts made of metal or unmagnetized ferromagnetic material.

A23. The support of A21, wherein the reference or excitation elements (N, S) are formed from a mouldable or injectable material, particularly a magnetizable thermoplastic-based material, such as plastic ferrite of the like.

A24. The support of any of A1-A23, wherein the series or sequence of reference or excitation elements (A1, A2; N, S) is arranged according to a circumference or an arc of circumference.

A25. The support of any of A1-A24, wherein the series or sequence of reference or excitation elements (A1, A2) has an at least partially linear development.

A26. The support of any of A1-A25, wherein said visual indicator (49, 49a, 49b) or said reference or excitation means (A; A′; A″; A1; A2; N, S) comprises a series or sequence of graphic and/or alphabetic and/or numeric symbols, or one or more writings.

A27. The support of A26, wherein said visual indicator (49, 49a, 49b) or said reference or excitation means (A; A′; A″; A1; A2; N, S) is provided within or on at least one of a peripheral circumferential wall (42) and an axial end wall (40a) of a support body (40).

A28. The support of any of A1-A27, wherein the reference or excitation means or elements (A; A′; A″; 49, 49a, 49b) are formed as one piece with the support (40; 40′; 40″; 240; 240′).

A29. The support of any of A1-A28, wherein the reference means or elements (A; A′; A″; 49, 49a, 49bA1, A2; N, S) are integrated in a support body (40; 40′; 40″; 240; 240′) by being inserted or fixed thereto during manufacture of the support (40; 40′; 40″; 240; 240′).

A30. The support of any of A1-A29, wherein said reference means or elements (A; A′; A″; 49, 49a, 49b; A1, A2; N, S) are applied to the support body (40; 40′; 40″; 240; 240′).

A31. The support of any of A1-A30, wherein the substance to be delivered is a washing agent.

A32. The support of any of A1-A30, wherein the substance to be delivered is a cosmetic.

A33. The support of any of A1-A30, wherein the substance to be delivered is a drug.

A34. The support of any of A1-A33, wherein said support (40; 40′; 40″; 240; 240′) comprises a plurality of seats (45; 45′; 45″; 245; 245′), at least one of said seats being suitable to face said delivery opening (33a; 33a′; 233), and in said support (40; 40′; 40″; 240; 240′) sealing means are provided which are suitable to isolate said at least one of said seats facing the delivery opening from all other seats.

A35. The support of A34, wherein said sealing means provide a fluidic isolating barrier between said at least one of said seats facing the delivery opening and all other seats.

A36. The support of A34, wherein said sealing means provide a heat insulating barrier between said at least one of said seats facing the delivery opening and all other seats.

A37. The support for at least one dose of deliverable substance, particularly though not exclusively according to any of definitions A1-A36, and which is arranged to be operatively coupled to a dispenser, the dispenser (10) being of the type comprising an actuating system (66, 67; 250) and a dispenser body (20, 30; 220, 230), having a positioning region (31; 231) for the support (40; 40′; 40″; 240; 240′) and a delivery opening (33a; 33a′; 233), wherein the support (40; 40′; 40″; 240; 240′) is intended to be either coupled to or inserted within the positioning region (31; 231) of the dispenser (10), such that a relative movement between the support (40; 40′; 40″; 240; 240′) and at least one part (30) of the dispenser body (20, 30; 220, 230) that is caused by the actuating system (66, 67; 250) allows selectively delivering the at least one dose (46; 246),

characterized in that the support (40; 40′; 40″; 240; 240′) comprises transmission means (47; 47′; 47a, 47b; 247) that are configured to co-operate in an uncouplable manner with the actuating system (66, 67; 250) of the dispenser (10).

A38. The support of any of A1-A37, for a dispenser suitable to be integrally and inseparably coupled to a body of a device being suitable to use the deliverable substance.

A39. The support of any of A1-A38, wherein said support is suitable to be controlled by means of control means that are comprised within said actuation system (66, 67; 250) of the dispenser.

A40. The support of any of A1-A39, wherein said support comprises means (40; 40′; 40″; 240; 240′) suitable to allow the latter to be controlled by the dispenser.

A41. The support of any of A1-A40, wherein said support (40; 40′; 40″; 240; 240′) comprises reference or excitation means (A; A′; A″; 49, 49a, 49b), in a predefined position relative to the at least one dose (46; 246) and configured to obtain or provide or generate, following said relative movement between the support (40; 40′; 40″; 240; 240′) and at least one part (30) of the dispenser body (20, 30; 220, 230), a piece of information or a figure.

A42. The support of any of A1-A41, wherein said information or a figure is preferably representative of at least one of:
an amount of substance dose (46; 246) provided within the support (40; 40′; 40″; 240; 240′),
a condition and/or a position of the support (40; 40′; 40″; 240; 240′) within the positioning region (31; 231).

A43. The support of any of A1-A42, wherein said at least one dose is a plurality of doses of deliverable substances.

A44. The support of any of A1-A43, for a long-life dispenser.

A45. The support of any of A1-A44, wherein said support is suitable to co-operate with said actuation system (66, 67; 250) of the dispenser (10).

A46. The support of any of A1-A45, wherein the support (40; 40′; 40″; 240; 240′) comprises a plurality of seats (45; 45′; 45″; 245; 245′), each being configured to at least partially accommodate one dose (46; 246), the number of doses in the plurality being sufficient to carry out several deliveries.

A47. The support of any of A1-A46, wherein said reference or excitation means (A; A′; A″; 49, 49a, 49b) are integrated in said support (40; 40′; 40″; 240; 240′).

A48. The support of any of A1-A47, wherein said reference or excitation means (A; A′; A″; 49, 49a, 49b) are made as one piece with said support (40; 40′; 40″; 240; 240′).

A49. The support of any of A1-A48, wherein said reference or excitation means (A; A′; A″; 49, 49a, 49b) are applied to said support (40; 40′; 40″; 240; 240′).

A50. The support of any of A1-A49, wherein said support is a blister.

A51. The support of any of A1-A50, wherein said support accommodates and supports a blister.

A52. The support of any of A1-A51, wherein said at least one dose of deliverable substance is firmly fastened to said support such that dissolving means can flow to said support and at least partially dissolve said dose and flow out together with the part of dissolved dose from a delivery opening (33a; 33a′; 233).

A53. The support of any of A1-A52, wherein said dissolving means flow to said support from a second opening separated from said delivery opening (33a; 33a′; 233), such that said dissolving means at least partially flow through said at least one dose.

A54. The support of any of A1-A53, wherein said at least one dose comprises two or more deliverable substances that are different from each other.

A55. The support of any of A1-A54, wherein the reference means (A; A′; A″; 49, 49a, 49b) comprise excitation means (A; A′; A″) that are provided on or within the support (40; 40′; 40″; 240; 240′) and configured to co-operate or interact with a detecting system (270; 270′) of the dispenser (10) in order to generate said information or figure.

A56. The support of any of A1-A55, wherein the reference or excitation means (A; A′; A″; 49, 49a, 49b) comprise a visual indicator (49, 49a, 49b) being provided on or within the support (40; 40′; 40″) and configured to visually display said information at a predefined position (38; 38″) of the dispenser body (20, 30).

A57. The support of any of A1-A56, wherein the reference or excitation means (A; A′; A″; 49, 49a, 49b) are configured to obtain information or value representative of at least one of:
a residual amount of substance doses (46; 246) provided within the support (40; 40′; 40″; 240; 240′),
a condition of presence/absence of the support (40; 40′; 40″; 240; 240′) in the positioning region (31; 231),
an operative position, among a plurality of possible operative positions, of the support (40; 40′; 40″; 240; 240′) within the positioning region (31; 231).

A58. The support of any of A1-A57, wherein the reference or excitation means (A; A′; A″; 49, 49a, 49b) are configured to simultaneously provide the following information or figures:
the residual amount of substance dose (46; 246) provided within the support (40; 40′; 40″; 240; 240′),
the operative position, among a plurality of possible operative positions, of the support (40; 40′; 40″; 240; 240′) within the positioning region (31; 231).

A59. The support of any of A1-A58, wherein said reference or excitation means (A; A′; A″; 49, 49a, 49b) are two separated reference or excitation means, wherein first reference or excitation means are configured to obtain or provide or generate the residual amount of substance dose (46; 246) that is present within the support (40; 40′; 40″; 240; 240′) and second reference or excitation means are configured to obtain or provide or generate the operative position, among a plurality of possible operative positions, of the support (40; 40′; 40″; 240; 240′) within the positioning region (31; 231).

A60. The support of any of A1-A59, wherein the reference or excitation means (A; A′; A″) comprise a series or sequence of excitation elements (A1, A2; N, S).

A61. The support of A60, wherein the reference or excitation elements (A1, A2; N, S) comprise at least one of
a series of relieves and/or cavities of a body of or on the support,
a series of transparent sectors and/or opaque sectors and/or reflecting sectors of a body of or on the support,
a series of magnetized inserts integrated in a body of or on the support,
a series of inserts made of metal or unmagnetized ferromagnetic material.

A62. The support of any of A1-A61, wherein the reference or excitation elements (N, S) are formed from a mouldable or injectable material, particularly a magnetizable thermoplastic-based material, such as plastic ferrite of the like.

A63. The support of any of A1-A62, wherein the series or sequence of reference or excitation elements (A1, A2; N, S) is arranged according to a circumference or an arc of circumference.

A64. The support of any of A1-A63, wherein the series or sequence of reference or excitation elements (A1, A2) has an at least partially linear development.

A65. The support of any of A1-A64 wherein said visual indicator (49, 49a, 49b) comprises a series or sequence of graphic and/or alphabetic and/or numeric symbols, or one or more writings.

A66. The support of any of A1-A65, wherein a visual indicator (49, 49a, 49b) is provided on at least one of a peripheral circumferential wall (42) and an axial end wall (40a) of a body of or on the support (40).

A67. The support of any of A1-A66, wherein the reference or excitation means (A; A′; A″; 49, 49a, 49b) are formed as one piece with the support (40; 40′; 40″; 240; 240′).

A68. The support of any of A1-A67, wherein the reference or excitation means (A; A′; A″; 49, 49a, 49b) are integrated or affixed in or on the support body (40; 40′; 40″; 240; 240′) by being inserted or fixed thereto during manufacture of the support (40; 40′; 40″; 240; 240′).

A69. The support of any of A1-A68, wherein the substance is a washing agent.

A70. The support of any of A1-A68, wherein the substance is a cosmetic.

A71. The support of any of A1-A68, wherein the substance is a drug.

A72. The support of any of A1-A71, wherein said support (40; 40′; 40″; 240; 240′) has a plurality of seats (45; 45′; 45″; 245; 245′), wherein one of said seats is suitable to face said delivery opening (33a; 33a′; 233), and wherein sealing means are comprised within said support (40; 40′; 40″; 240; 240′) which are suitable to isolate said at least one of said seats facing the delivery opening from all other seats.

A73. The support of A72, wherein said sealing means provide a fluidic isolating barrier between said at least one of said seats facing the delivery opening and all other seats.

A74. The support of A72, wherein said sealing means provide a heat insulating barrier between said at least one of said seats facing the delivery opening and all other seats.

A75. The support of any of A1-A74, which is configured for angular movement and having a body with a central tubular portion (41; 41′; 41″; 241) that extends according to an axis of rotation of the support (40; 40′; 40″; 240′), the transmission means (47; 47′; 47a, 47b) being provided into or onto said tubular portion (41; 41′; 41″; 241).

A76. The support of any of A1-A75, which is configured for the linear movement and having a longitudinally extended body, the transmission means (247) being provided on at least one peripheral wall of the support body (240).

A77. The support of any of A1-A76, wherein the transmission means comprise a sequence of teeth (47; 247).

A78. The support of A77, wherein the teeth (47) are substantially saw teeth.

A79. The support of A78, wherein the teeth (47) have a non-plane front profile, particularly a substantially V-shaped profile suitable to self-centre said support on the dispenser (10).

A80. The support of A77 or A78 or A79, wherein the teeth (47) in the sequence are arranged substantially according to a circumference.

A81. The support of A77 or A78 or A79, wherein the sequence of teeth (247) is substantially shaped as a rack.

A82. The support of any of A1-A81, which is configured for the angular movement within the positioning region (31) and having a respective body with a central tubular portion (41; 41′; 41″; 241), the tubular portion extending according to an axis of rotation of the support and transmission means (47; 47′; 47a, 47b) being provided at said central tubular portion (41; 41′; 41″; 241).

A83. The support of any of A1-A82, wherein the transmission means (47) are formed on a flange-like part (41a) that is formed at or within the tubular portion (41; 241) and particularly comprise a ring gear.

A84. The support of any of A1-A83, wherein the transmission means comprise an alternated series of relieves (47a) and cavities (47b) defined in an inner cylindrical surface of the tubular portion (41; 41″).

A85. The support of any of A1-A84, wherein the transmission means (47′) are arranged for coupling in a univocal position relative to the actuating system of the dispenser.

A86. The support of any of A1-A85, wherein the transmission means (47′) comprise at least one of a groove and an axial relief of the tubular portion (41).

A87. The support of any of A1-A86, wherein said support is suitable to be coupled to a dispenser which is fastened in a non-separable manner to a device suitable to receive the deliverable substance that is accommodated within said support and delivered by said dispenser.

A88. A support for at least one dose of deliverable substance, particularly though not exclusively a support of any of A1 to A87, and which is arranged to be operatively coupled to a dispensing device, the dispenser (10) being of the type comprising an actuating system (66, 67; 250) and a dispenser body (20, 30; 220, 230), having a positioning region (31; 231) for the support (40; 40′; 40″; 240; 240′) and a delivery opening (33a; 33a′; 233), said dispenser being fastened in a non-separable manner to a device suitable to receive said deliverable substance that is delivered by said dispenser,

wherein the support (40; 40′; 40″; 240; 240′) is intended to be either coupled to or inserted within the positioning region (31; 231) of the dispenser (10), such that a relative movement between the support (40; 40′; 40″; 240; 240′) and at least one part (30) of the dispenser body (20, 30; 220, 230) that is caused by the actuating system (66, 67; 250) allows selectively delivering at least one dose (46; 246),

characterized in that said at least one dose of deliverable substance is, at least at the beginning of the delivery, firmly fastened to said support such that dissolving means can flow to said support and at least partially dissolve said dose and flow out together with the part of dissolved dose from said delivery opening (33a; 33a′; 233).

A89. The support of any of A1-A88, wherein said dissolving means flow to said support from a second opening separated from said delivery opening (33a; 33a′; 233), such that said dissolving means at least partially flow through said at least one dose.

A90. The support of any of A1-A89, wherein said support (40; 40′; 40″; 240; 240′) comprises transmission means (47; 47′; 47a, 47b; 247) that are configured to co-operate in an uncouplable manner with the actuating system (66, 67; 250) of the dispenser (10).

A91. The support of any of A1-A90, wherein said dispenser is integrally and inseparably coupled to a body of a device suitable to use the deliverable substance.

A92. The support of any of A1-A91, wherein said support is suitable to have a relative position relative to the dispenser (10) by means of an actuation system (66, 67; 250) being either commanded or controlled by the dispenser (10).

A93. The support of any of A1-A92, wherein said support (40; 40′; 40″; 240; 240′) comprises reference or excitation means (A; A′; A″; 49, 49a, 49b) that are in a preset position relative to the at least one dose (46; 246) and configured to obtain or provide or generate, following said relative movement between the support (40; 40′; 40″; 240; 240′) and at least one part (30) of the dispenser body (20, 30; 220, 230), a piece of information or figure.

A94. The support of any of A1-A93, wherein said information or figure is representative of at least one of:
an amount of substance dose (46; 246) provided within the support (40; 40′; 40″; 240; 240′),
a condition and/or a position of the support (40; 40′; 40″; 240; 240′) within the positioning region (31; 231).

A95. The support of any of A1-A94, wherein said at least one dose is a plurality of doses of deliverable substances.

A96. The support of any of A1-A95, for a long-life dispenser.

A97. The support of any of A1-A96, wherein said support is suitable to co-operate with an actuation system (66, 67; 250) of the dispenser (10).

A98. The support of any of A1-A97, wherein the support (40; 40′; 40″; 240; 240′) defines a plurality of seats (45; 45′; 45″; 245; 245′), each being configured to at least partially accommodate one dose (46; 246), the number of doses in the plurality being sufficient to carry out several deliveries.

A99. The support of any of A78 to A87, wherein said reference or excitation means (A; A′; A″; 49, 49a, 49b) are integrated in or applied within/to said support (40; 40′; 40″; 240; 240′).

A100. The support of any of A1-A99, wherein said support is a blister.

A101. The support of any of A1-A100, wherein said support accommodates and supports a blister.

A102. The support of any of A1-A101, wherein said at least one dose of deliverable substance is, at least at the beginning of the delivery, firmly fastened to said support such that dissolving means can flow to said support and at least partially dissolve said dose and flow out together with the part of dissolved dose from said delivery opening (33a; 33a′; 233).

A103. The support of A102, wherein said dissolving means flow to said support from a second opening separated from said delivery opening (33a; 33a′; 233), such that said dissolving means at least partially flow through said at least one dose.

A104. The support of any of A1-A103, wherein said at least one dose comprises two or more deliverable substances that are different from each other.

A105. The support of any of A1-A104, wherein the reference or excitation means (A; A′; A″; 49, 49a, 49b) comprise excitation means (A; A′; A″) that are provided in or on the support (40; 40′; 40″; 240; 240′) and configured to co-operate or interact with a detecting system (270; 270′) of the dispenser (10) in order to generate said information or figure.

A106. The support of any of A1-A105, wherein the reference or excitation means (A; A′; A″; 49, 49a, 49b) comprise a visual indicator (49, 49a, 49b) being provided in or on the support (40; 40′; 40″) and configured to display said information at a predefined position (38; 38″) of the dispenser body (20, 30).

A107. The support of any of A1-A106, wherein the reference or excitation means (A; A′; A″; 49, 49a, 49b) are configured to provide a piece of information or value representative of at least one of:
a residual amount of substance doses (46; 246) provided within the support (40; 40′; 40″; 240; 240′),
a condition of presence/absence of the support (40; 40′; 40″; 240; 240′) in the positioning region (31; 231),
an operative position, among a plurality of possible operative positions, of the support (40; 40′; 40″; 240; 240′) within the positioning region (31; 231).

A108. The support of any of A1-A107, wherein the reference or excitation means (A; A′; A″; 49, 49a, 49b) are configured to simultaneously provide the following information or figures:
the residual amount of substance dose (46; 246) provided within the support (40; 40′; 40″; 240; 240′),
the operative position, among a plurality of possible operative positions, of the support (40; 40′; 40″; 240; 240′) within the positioning region (31; 231).

A109. The support of A108, wherein said reference or excitation means (A; A′; A″; 49, 49a, 49b) are two separated reference or excitation means, of which first reference or excitation means are configured to provide the residual amount of substance dose (46; 246) provided within the support (40; 40′; 40″; 240; 240′) and second reference or excitation means are configured to provide the operative position, among a plurality of possible operative positions, of the support (40; 40′; 40″; 240; 240′) within the positioning region (31; 231).

A110. The support of any of A1-A109, wherein the reference or excitation means (A; A′; A″) comprises a series or sequence of excitation elements (A1, A2; N, S).

A111. The support of A110, wherein the reference or excitation elements (A1, A2; N, S) comprise at least one of
a series of relieves and/or cavities of a support body,
a series of transparent sectors and/or opaque sectors and/or reflecting sectors of a support body,
a series of magnetized inserts integrated in a support body,
a series of inserts made of metal or unmagnetized ferromagnetic material.

A112. The support of A110, wherein the excitation elements (N, S) are formed from a mouldable or injectable material, particularly a magnetizable thermoplastic-based material, such as plastic ferrite of the like.

A113. The support of any of A1-A112, wherein the series or sequence of reference or excitation elements (A1, A2; N, S) is arranged according to a circumference or an arc of circumference.

A114. The support of any of A1-A113, wherein the series or sequence of reference or excitation elements (A1, A2) has an at least partially linear development.

A115. The support of any of A1-A114, wherein said visual indicator (49, 49a, 49b) comprises a series or sequence of graphic and/or alphabetic and/or numeric symbols, or one or more writings.

A116. The support of any of A1-A115, wherein said visual indicator (49, 49a, 49b) is provided on at least one of a peripheral circumferential wall (42) and an axial end wall (40a) of a support body (40).

A117. The support of any of A1-A116, wherein the reference or excitation means (A; A′; A″; 49, 49a, 49b) are formed as one piece with the support (40; 40′; 40″; 240; 240′).

A118. The support of any of A1-A44, wherein the reference or excitation means (A; A′; A″; 49, 49a, 49b) are integrated or affixed in/on the support body (40; 40′; 40″; 240; 240′) by being inserted or fixed thereto during manufacture of the support (40; 40′; 40″; 240; 240′).

A119. The support of any of A1-A118, wherein the substance is a washing agent.

A120. The support of any of A1-A118, wherein the substance is a cosmetic.

A121. The support of any of A1-A118, wherein the substance is a drug.

A122. The support of any of A1-A121, wherein said support (40; 40′; 40″; 240; 240′) defines a plurality of seats (45; 45′; 45″; 245; 245′), wherein one of said seats is suitable to face said delivery opening (33a; 33a′; 233), and sealing means are provided to isolate said at least one of said seats facing the delivery opening from all other seats.

A123. The support of A122, wherein said sealing means are a fluidic isolating barrier between said at least one of said seats facing the delivery opening and all other seats.

A124. The support of A122, wherein said sealing means are a heat insulating barrier between said at least one of said seats facing the delivery opening and all other seats.

A125. The support of any of A1-A124, which is configured for angular movement and has a body with a central tubular portion (41; 41′; 41″; 241) that extends according to an axis of rotation of the support (40; 40′; 40″; 240′), transmission means (47; 47′; 47a, 47b) being provided into or onto said tubular portion (41; 41′; 41″; 241).

A126. The support of any of A1-A125, which is configured for the linear movement and has a longitudinally extended body, transmission means (247) being provided on at least one peripheral wall of the support body (240).

A127. The support of any of A1-A126, wherein the transmission means comprises a sequence of teeth (47; 247).

A128. The support of A127, wherein the teeth (47) are substantially saw teeth.

A129. The support of A127 or A128, wherein the teeth (47) have a non-plane front profile, particularly a substantially V-shaped profile suitable to self-center said support on the dispenser (10).

A130. The support of A127 or A128 or A129, wherein the teeth (47) in the sequence are arranged substantially according to a circumference.

A131. The support of A127 or A128 or A129, wherein the sequence of teeth (247) is substantially shaped as a rack.

A132. The support of any of A1-A131, which is configured for the angular movement within the positioning region (31) and having a respective body with a central tubular portion (41; 41′; 41″; 241), the tubular portion extending according to an axis of rotation of the support and the transmission means (47; 47′; 47a, 47b) being provided at said central tubular portion (41; 41′; 41″; 241).

A133. The support of any of A1-A132, wherein the transmission means (47) are formed in or on a flange-like part (41a) that is formed at or within the tubular portion (41; 241) and particularly comprise a ring gear.

A134. The support of any of A1-A133, wherein the transmission means comprise an alternated series of relieves (47a) and cavities (47b) defined in an inner cylindrical surface of the tubular portion (41; 41″).

A135. The support of any of A1-A134, wherein the transmission means (47′) are arranged for coupling in a univocal position relative to the actuating system of the dispenser.

A136. The support of any of A1-A135, wherein the transmission means (47′) comprise at least one of a groove and an axial relief of the tubular portion (41).

A137. A support for a plurality of separate doses of deliverable substances, particularly though not exclusively of A1 to A136, and which is arranged to be operatively coupled to a long-life dispenser, the dispenser (10) being of the type comprising an actuating system (66, 67; 250) that can be controlled by the dispenser and a dispenser body (20, 30; 220, 230) having a positioning region (31; 231) for the support (40; 40′; 40″; 240; 240′) and a delivery opening (33a; 33a′; 233),

wherein the support (40; 40′; 40″; 240; 240′) defines a plurality of seats (45; 45′; 45″; 245; 245′), each being configured to at least partially accommodate one dose (46; 246) of said plurality, the number of doses of the plurality being sufficient to carry out several deliveries,

and wherein the support (40; 40′; 40″; 240; 240′) is intended to be either coupled or inserted within the positioning region (31; 231) of the dispenser (10), such that a relative movement between the support (40; 40′; 40″; 240; 240′) and at least one part (30) of the dispenser body (20, 30; 220, 230) that is caused by the actuating system (66, 67; 250), allows selectively delivering one dose (46; 246) of the substance,

characterized in that the support (40; 40′; 40″; 240; 240′) has a body that is formed as one piece of a substantially rigid material and defining a containment volume for the doses (46, 246) that is divided into said seats (245).

A138. The support of A137, having a respective body with a central portion (41; 41′; 41″; 241), a plurality of radial walls (44; 44′; 44″; 244) extending therefrom, which define said seats (45; 45′; 45″; 245; 245′).

A139. The support of A137 or A138, wherein the central portion (41; 41′; 41″; 241) is substantially tubular and has, preferably therein, transmission means (47; 47′; 47a, 47b) being configured to co-operate with the actuating system (66, 67) of the dispenser (10) when the support (40; 40′; 40″; 240′) is in the positioning region (31).

A140. The support of A138 or A139, wherein the support body (40; 40″) further comprises a peripheral wall (42; 42″), the radial walls (44; 44″) extending between said central portion (41; 41″) and said peripheral wall (42; 42″).

A141. The support of A140, wherein the peripheral wall (42; 42″) is substantially cylindrical, or substantially cylindrical sector shaped, or substantially truncated cone shaped.

A142. The support of A138, wherein the support body has at least one of an upper wall (43′) and a lower wall (43′) and the seats (45′) are opened at a respective radial end thereof.

A143. The support of any of A1 to A142, wherein the seats (45; 45″; 245; 245′) are opened at least one respective axial end thereof.

A144. The support according to any of A1 to A143, wherein with said peripheral wall (42) is associated at least one of one notch and one projection, which is arranged to facilitate a manual positioning of the support in a predefined angular position within the positioning region (31).

A145. The support of A137, having a respective body of an overall prismatic or longitudinally extended shape, defining a containment volume that is divided into said seats (245).

A146. The support of A145, wherein the support body has a substantially parallelepiped shape, and comprises two end walls, two side walls and a bottom wall.

A147. The support of A145 or A146, wherein said support is a blister.

A148. The support of any of A1-A147, wherein said support accommodates and supports a blister.

A149. The support of any of A1-A148, wherein said at least one dose of deliverable substance is, at least at the beginning of the delivery, firmly fastened to said support such that dissolving means can flow to said support and at least partially dissolving said dose and flow out together with the part of dissolved dose from said delivery opening (33a; 33a′; 233).

A150. The support of A149, wherein said dissolving means flow to said support from a second opening separated from said delivery opening (33a; 33a′; 233), such that said dissolving means at least partially flow through said at least one dose.

A151. The support of any of A1-A150, wherein one of the side and bottom walls has the shape of a rack, configured for co-operating with the actuating system (250) of the dispenser (10) when the support (240) is in the positioning region (231).

A152. The support of any of A1-A151, wherein the containment volume is divided into said seats (245) by means of a plurality of walls that are substantially parallel to each other and perpendicular to a maximum length dimension of the support body (240).

A153. The support of any of A1-A152, wherein at least one peripheral wall of the support body is inclined.

A154. The support of any of A1-A153, wherein with the support body (40; 40′; 240″; 240; 240′) are removably associated closing means for the seats (45; 45′; 45″; 245), particularly in the form of safety film or lid.

A155. The support of any of A1-A154, wherein in said seats (45b, 45c) there are at least partially housed doses (46a, 46b) of at least two different types (43) of substances.

A156. The support of any of A1-A155, wherein the seats are substantially wedge-shaped or cylindrical sector shaped, and/or
are substantially arranged according to a circumference.

A157. The support of one or more of A1 to A156, wherein the seats are substantially cone sector shaped or truncated cone shaped.

A158. The support of one or more of A1 to A157, wherein the seats
are substantially prism shaped or prism sector shaped or parallelepiped shaped, and/or
   have at least one rectangular or trapezoid or triangular section.

A159. The support of one or more of A1 to A158, having a respective body that is arranged to support a respective blister package (300) defining a plurality of alveoli containing a deliverable substance (345), the substance contained in each alveolus (345) providing one said dose (246), each alveolus (345) having such a shape that is at least partially complementary or receivable within one said seat (45; 45′; 45″; 245; 245′).

A160. The support of A159, wherein the support body (40; 40′; 40″; 240; 240′) has one or more portions that are arranged (44; 44′; 44″; 244) for engagement with respective portions (345a) of the blister package (300).

A161. The support of any of A1-A160, wherein said support comprises means suitable to store or communicate information indicative of the position of the support within the dispenser and/or the type of support and/or the substance/s to be delivered and/or the position thereof within the support.

A162. The support of any of A1-A161, wherein said support comprises means suitable to allow detecting the relative position of the support by the dispenser.

A163. The support of any of A1-A162, wherein means are provided to excite a substantially analogue position transducer, particularly to the purpose of the direct or indirect detection of the position and/or movement of the support means for the substance to be delivered or its refill or blister.

A164. The support of any of A1-A164, wherein said support or refill (240) has, along one of the sides thereof being directed in the direction of movement, excitation means (C′) or a readable profile or an inclined plane (P).

A165. The support of A164, wherein said inclined plane (P) or said excitation means (C′) are formed of magnetic material or magnetized plastic ferrite.

A166. The support of A164, wherein said inclined plane (P) or said excitation means (C′), are intended to result more or less proximate, as a function of the movement of the support or refill (240), to a respective analogue sensor, which is mounted to the dispenser and suitable to output a signal proportional to the distance of the latter from the inclined plane (P) or excitation means.

A167. The support of A164, wherein said inclined plane (P) or said excitation means (C′), as a function of the movement of the support or refill (240), are suitable to induce more or less strong variations in the signal of a respective sensor means (70″), the value of which varies proportionally with the movement or travel of the inclined plane (P) or excitation means relative to the position of a sensor.

A168. The support of any of A164 to A167, wherein said support is suitable for a rotary movement and said inclined plane is an eccentric or spiral profile (P).

A169. The support of any of A1 to A168, wherein at least one wall of the seats is inclined.

A170. The support of one or more of A1 to A169, wherein at least one wall is inclined relative to an axis of movement of the support.

B171. A blister package having a plurality of alveoli containing at least one substance, which is arranged to be associated with a support of a long-life dispenser (10), the blister package (340) having a respective body, which is at least partially substantially shaped complementary to the support (40; 40′; 40″; 240; 240′).

B172. The blister package of B171, which is arranged for use in combination with a support according to one or more of the preceding statements A1-A171.

B173. The blister package of B171 or B172, wherein regions or transmission means (345a) are defined between the alveoli (345), which are arranged to receive respective portions (44; 44′; 44″; 244) of the support (40; 40′; 40″; 240; 240′).

B174. The blister package of any of B171 to B173, having a main body defining said alveoli (345), a film closing at least part of the alveoli being removably associated therewith.

B175. The blister package of any of B171 to B174, having a substantially flattened cylindrical overall shape, wherein the alveoli (345) are substantially arranged according to a circumference.

B176. The blister package of any of B171 to B175, having an axially extended shape, wherein the alveoli (345) are in side-by-side positions.

B177. The blister package of B176, having a main flexible body, which is capable of being deformed in a substantially circular configuration in order to be positioned on a respective support (40′).

B178. The blister package of any of B171-B177, wherein the alveoli (345) are substantially wedge-like shaped or trapezoid shaped or cylindrical sector shaped.

C179. A kit of parts, comprising a support of one or more of statements A1 to A170 and a blister package of one or more of statements B171 to B178.

D180. A method for instructing a user to use a support for at least one dose of deliverable substance in a dispenser, wherein the instructions for the user comprise the following steps:
providing a support of any of statements A1 to A170;
exposing at least one portion of said at least one dose through said delivery opening to dissolving means, such that said dissolving means can flow to said support and at least partially dissolving said dose, and then flow out together with the dissolved dose from said delivery opening (33a; 33a′; 233).

D181. A method for mounting a support for at least one dose of a deliverable substance in a dispenser, wherein at least two of the following steps are provided:
providing a support of any of statements A1 to A170;
inserting said support within the positioning region (31; 231) of the dispenser (10);
manually moving said support for aligning one dose with an opening or position of the dispenser.

D182. A method for manufacturing a support for a deliverable substance, preferably though not exclusively according to any one of statements A1 to A170, wherein at least the following steps are provided:
providing at least one mould having a suitable shape to make said support and at least one of said excitation or reference means;
injecting at least one material suitable to provide said support and at least one of said excitation or reference means.

D183. The method of D182 wherein at least the following steps are provided:
providing a first mould with a shape suitable to make both the support and at least one of said excitation or reference means as one piece;
injecting a first material suitable to make both said support and at least one of said excitation or reference means as one piece.

D184. The method of D182 wherein at least the following steps are provided:
providing a first mould, consisting of at least one first part and a second part of mould with a shape suitable to make the support;
injecting a first material in said first mould to make said support;
removing at least one of said first and second parts of the first mould;
providing at least one second part of mould with a shapes suitable to make at least part of said excitation or reference means;
injecting a second material suitable to make at least part of said excitation or reference means of said support.

D185. The method of D182 wherein at least the following steps are provided:
providing a first mould with a shape suitable to make the support;
injecting a first material in said first mould to make said support;
removing said support from said first mould;
providing a second mould with a shape suitable to make at least part of said excitation or reference means;
inserting said support within said second mould;
injecting a second material suitable to make at least part of said excitation or reference means of said support.

D186. The method of D182 wherein at least the following steps are provided:
providing a first mould with a shape suitable to make the support and being provided with at least one seat for at least one insert;
positioning at least one insert within said at least one seat of the first mould suitable to make said excitation or reference means;
injecting a material within said first mould which is suitable to make said support.

D187. The method of D186 wherein at least one of the following steps is provided:
providing at least one magnetic or magnetized insert within at least one seat of the mould;
providing at least one metal or ferromagnetic insert within at least one seat of the mould.

D188. The method of any of D182-D187 wherein at least one of the following steps is provided:
injecting a thermoplastic material and/or an elastomer;
injecting a material, either molten or fluidized following a heating operation;
injecting a resin or fluid material suitable for hardening after injection;
inject a material suitable for hardening within the mould;
injecting a plastic ferrite.

D189. The method of at least one of D182-D188 wherein at least one of the following further steps is provided:
magnetizing said at least one insert;
magnetizing said excitation or reference means;
magnetizing said support

D190. The method for manufacturing a support for a deliverable substance, preferably though not exclusively according to any of the statements A1 to A170, wherein at least the following steps are provided:
providing at least one mould with a shape suitable to make said support;
injecting at least one material suitable to make said support;
fixing or gluing or welding detection or excitation means or elements to the support.

D191. The method of D190 wherein at least one of the following further steps is provided:
fixing or gluing or welding at least one optical element;
fixing or gluing or welding at least one magnetic element;
fixing or gluing or welding at least one reflecting or coloured element with graphic symbols.

E192. A mould for manufacturing a support of any of the statements A1 to A170, according to a method of any of the statements D182 to D191.

A193. The support of any of A1 to A170, wherein sealing means are provided which also implement at least part of the reference or excitation means or elements (A; A′; A″; 49, 49a, 49b; A1, A2; N, S).

A194. The support of any of A1 to A170 or A193, wherein the excitation means, by moving at either a constant or variable distance relative to the dispenser sensor means, are capable of inducing more or less strong variations in the signal from said dispenser sensor means, the value of which is proportional to the position or travel of the excitation means or support relative to the position of said dispenser sensor means.

A195. The support of any of A1 to A170 or A193 or A194, wherein said support comprises information means comprising information suitable to be detected by dispenser detection means.

E196. A method for instructing a user to use a support for at least one dose of deliverable substance in a dispenser, wherein the instructions comprise the following steps:

providing a support of any of statements A1 to A170;
positioning the support within a dispenser, such that the dispenser can
exposing at least one portion of said at least one dose through said delivery opening to dissolving means, such that said dissolving means can flow to said support and at least partially dissolving said dose, and then flow out together with the dissolved dose from said delivery opening (33a; 33a′; 233).

F197. A method for using a support for at least one dose of deliverable substance in a dispenser, comprising the following steps:
providing a support of any of statements A1 to A170;
dissolving at least one portion of said at least one dose by means of dissolving means, such that said dissolving means can flow to said support and at least partially dissolve said dose and then flow out together with the part of dissolved dose.

G198. The support for implementing a method of one or more of the preceding statements numbered 171 to 197.

H199. The support of any of A1 to A170 and A193 to A195, for implementing a feature of one or more of statements numbered 171 to 192 and 196 to 197.

1. A support for at least one dose of a deliverable substance, which support is arranged to be operatively coupled to a dispenser, the dispenser comprising an actuating system and a dispenser body having a positioning region for the support and a delivery opening, wherein the support is adapted to be either coupled to or inserted within the positioning region of the dispenser, such that relative movement between the support and at least one part of the dispenser body, caused by the actuating system, allows the selective delivery of the said at least one dose, and wherein
the support further comprises reference or excitation means in a predefined position relative to the at least one dose and configured to obtain or provide or generate, a piece of information or a datum following said relative movement between the support and at least one part of the dispenser body.

2. The support according to claim 1, wherein said information or datum is representative of at least one of:
a) the amount of deliverable substance provided within the support,
b) the condition and/or the position and/or the movement of the support within the positioning region.

3. The support according to claim 1, wherein said support is a blister package.

4. The support according to claim 1, wherein the reference means comprises excitation means that is provided on the support and configured to co-operate or interact with a detecting system of the dispenser and thereby generate said information or datum.

5. The support according to claim 1, wherein the reference or excitation means is configured to obtain or provide or generate a piece of information or value representative of at least one of:
a) residual amount of substance doses provided within the support,
b) a condition of either the presence or absence of the support in the positioning region,
c) an operative position, among a plurality of possible operative positions, of the support within the positioning region.

6. The support according to claim 4, wherein the reference or excitation element comprises at least one of
a) a series of projections or cavities of a support body,
b) a series of transparent sectors or opaque sectors and/or reflecting sectors of a support body,
c) a series of magnetized inserts integrated in a support body,
d) a series of inserts made of metal or unmagnetized ferromagnetic material.

7. The support according to claim 1, wherein said support comprises a plurality of seats, at least one of said seats being adapted to face said delivery opening, and in said support sealing means are provided which are suitable to isolate said at least one of said seats facing the delivery opening from all other seats.

8. A support for at least one dose of deliverable substance, which support is arranged to be operatively coupled to a dispenser, the dispenser comprising an actuating system and a dispenser body, having a positioning region for the support and a delivery opening,
wherein the support is adapted to be either coupled to or inserted within the positioning region of the dispenser, such that a relative movement between the support and at least one part of the dispenser body that is caused by the actuating system allows for selective delivery of the at least one dose (46; 246), further wherein the support comprises transmission means configured to co-operate in an uncouplable manner with the actuating system of the dispenser.

9. A support for at least one dose of deliverable substance, which support is arranged to be operatively coupled to a dispensing device, the dispenser comprising an actuating system and a dispenser body, having a positioning region for the support and a delivery opening, said dispenser being fastened in a non-separable manner to a device suitable to receive said deliverable substance that is delivered by said dispenser,
wherein the support is adapted to be either coupled to or inserted within the positioning region of the dispenser, such that a relative movement between the support and at least one part of the dispenser body that caused by the actuating system allows for the selective delivery of the at least one dose (46; 246), further wherein, the at least one dose of deliverable substance is, at least at the beginning of the delivery, firmly fastened to said support such that dissolving means can flow to said support and at least partially dissolve said dose and flow out together with the part of dissolved dose from said delivery opening.

10. A support for a plurality of separate doses of deliverable substances, which support is arranged to be operatively coupled to a dispenser, the dispenser being of the type comprising an actuating system that can be controlled by the dispenser and a dispenser body having a positioning region for the support and a delivery opening, wherein the support defines a plurality of seats, each being configured to at least partially accommodate one dose of said plurality, the number of doses of the plurality being sufficient to carry out several deliveries, and wherein the support is adapted to be either coupled or inserted within the positioning region of the dispenser, such that a relative movement between the support and at least one part of the dispenser body that is caused by the actuating system allows for selective delivery of one dose of the substance, further wherein that the support has a body that is formed as one piece of a substantially rigid material and defining a containment volume for the doses that is divided into said seats.

11. A blister package having a plurality of alveoli containing mutually isolated doses of a substance, the package adapted to be associated with a support of a dispenser, the blister package having a respective body, which nests against or within the support.

12. A kit of parts, comprising a support according to claim 1 and a blister package having a plurality of alveoli containing mutually isolated doses of a substance, the package adapted to be associated with a support of a dispenser, the blister package having a respective body, which nests against or within the support.

13. The method for manufacturing a support for a deliverable substance according to claim 1, comprising the steps of:
1) providing at least one mould having a suitable shape to make said support and at least one of said excitation or reference means;
2) injecting at least one material suitable to provide said support and
3) subsequently, introducing at least one of said excitation or reference means.

14. A method for using a support for at least one dose of deliverable substance in a dispenser, comprising the following steps:
providing a support according to claim 1; and
dissolving at least one portion of said at least one dose by means of dissolving means, such that said dissolving means can flow to said support and at least partially dissolve said dose and then flow out together with the part of dissolved dose.
